(19) United States
(12) Patent Application Publication
(10) Pub. No.: US 2008/0268321 A1
(43) Pub. Date: Oct. 30, 2008

(54) Membrane-Electrode Units and Fuel Cells Having a Long Service Life

(75) Inventors: Oemer Uensal, Mainz (DE); Thomas Schmidt, Moerfelden-Walldorf (DE); Christoph Padberg, Wiesbaden (DE); Detlef Ott, Sulzbach (DE)

Correspondence Address: CONNOLLY BOVE LODGE & HUTZ, LLP, P O BOX 2207, WILMINGTON, DE, 19899, US

(73) Assignee: BASF Fuel Cell GmbH, Frankfurt Am Main (DE)

(21) Appl. No.: 12/063,339

(22) PCT Filed: Aug. 5, 2006
(86) PCT No.: PCT/EP06/07767

§ 371 Date: Jul. 10, 2008

(30) Foreign Application Priority Data
Aug. 12, 2005 (DE) 10 2005 038 195.2

(51) Int. Cl. H01M 2/00; H01M 4/00

(52) U.S. Cl. 429/34; 429/40

(57) ABSTRACT

The present invention relates to a membrane electrode unit having two gas diffusion layers, each contacted with a catalyst layer, which are separated by a polymer electrolyte membrane, wherein the polymer electrolyte membrane has an inner area which is contacted with a catalyst layer, and an outer area which is not provided on the surface of a gas diffusion layer, characterized in that the thickness of the inner area of the membrane decreases over a period of 10 minutes by at least 5% at a pressure of 5 N/mm² and the thickness of the membrane in the outer area is greater than the thickness of the inner area of the membrane.

The present invention relates to improved membrane electrode units and fuel cells with long service life, having two electrochemically active electrodes, which are separated by a polymer electrolyte membrane.

Nowadays, as proton-conducting membranes in polymer electrolyte membrane (PEM) fuel cells, sulphonic acid-modified polymers are almost exclusively employed. Here, predominantly perfluorinated polymers are used. Nation™ from DuPont de Nemours, Willmington, USA is a prominent example of this. For the conduction of protons, a relatively high water content is required in the membrane, which typically amounts to 4-20 molecules of water per sulphonic acid group. The required water content, but also the stability of the polymer in connection with acidic water and the reaction gases hydrogen and oxygen, restricts the operating temperature of the PEM fuel cell stacks to 80-100° C. Higher operating temperatures cannot be implemented without a decrease in performance of the fuel cell. At temperatures higher than the dew point of water for a given pressure level, the membrane dries out completely and the fuel cell provides no more electric power as the resistance of the membrane increases to such high values that an appreciable current flow no longer occurs.

A membrane electrode unit with integrated gasket based on the technology set forth above is described, for example, in U.S. Pat. No. 5,464,700. Here, in the outer area of the membrane electrode unit, films made of elastomers are provided on the surfaces of the membrane that are not covered by the electrode which simultaneously constitute the gasket to the bipolar plates and the outer space.

By means of this measure, savings on very expensive membrane material can be achieved. Further advantages that may be obtained by means of this structure relate to the contamination of the membrane. An improvement of the long-term stability is not demonstrated in U.S. Pat. No. 5,464,700. This is also due to the very low operating temperatures. In the description of the invention set forth in U.S. Pat. No. 5,464,700, it is indicated that the operating temperature of the cell is limited to a temperature of up to 80° C. Elastomers are usually also only suitable for long-term service temperatures of up to 100° C. It is not possible to achieve higher working temperatures with elastomers. Therefore, the method described herein is not suitable for fuel cells with operating temperatures of more than 100° C.

Due to system-specific reasons, however, operating temperatures in the fuel cell of more than 100° C. are desirable. The activity of the catalysts based on noble metals and contained in the membrane electrode unit (MEU) is significantly improved at high operating temperatures.

Especially when the so-called reformates from hydrocarbons are used, the reformer gas contains considerable amounts of carbon monoxide which usually have to be removed by means of an elaborate gas conditioning or gas purification process. The tolerance of the catalysts to the CO impurities is increased at high operating temperatures.

Furthermore, heat is produced during operation of fuel cells. However, the cooling of these systems to less than 80° C. can be very complex. Depending on the power output, the cooling devices can be constructed significantly less complex. This means that the waste heat in fuel cell systems that are operated at temperatures of more than 100° C. can be utilised distinctly better and therefore the efficiency of the fuel cell system can be increased.

To achieve these temperatures, in general, membranes with new conductivity mechanisms are used. One approach to this end is the use of membranes which show ionic conductivity without employing water. The first promising development in this direction is set forth in the document WO96/13872.

In this document, there is also described a first method for producing membrane electrode units. To this end, two electrodes are pressed onto the membrane, each of which only covers part of the two main surfaces of the membrane. A PTFE gasket is pressed onto the remaining exposed part of the main surfaces of the membrane in the cell such that the gas spaces of anode and cathode are sealed in respect to each other and the environment. However, it was found that a membrane electrode unit produced in such a way only exhibits high durability with very small cell surface areas of 1 cm². If bigger cells, in particular with a surface area of at least 10 cm², are produced, the durability of the cells at temperatures of more than 150° C. is limited to less than 100 hours.

Another high-temperature fuel cell is disclosed in document JP-A-2001-1960982. In this document, an electrode membrane unit is presented which is provided with a polyimide gasket. However, the problem with this structure is, that for sealing two membranes are required between which a seal ring made of polyimide is provided. As the thickness of the membrane has to be chosen as little as possible due to technical reasons, the thickness of the seal ring between the two membranes described in JP-A-2001-196082 is extremely restricted. It was found in long-term tests that such a structure is likewise not stable over a period of more than 1000 hours.

Furthermore, a membrane electrode unit is known from DE 10235360 which contains polyimide layers for sealing. However, these layers have a uniform thickness such that the boundary area is thinner than the area which is in contact with the membrane.

The membrane electrode units mentioned above are generally connected with planar bipolar plates which include channels for a flow of gas milled into the plates. As part of the membrane electrode units has a higher thickness than the gaskets described above, a gasket is inserted between the gasket of the membrane electrode units and the bipolar plates which is usually made of PTFE.

It was now found that the service life of the fuel cells described above is limited.

Therefore, it is an object of the present invention to provide an improved MEU and the fuel cells operated therewith which preferably should have the following properties:
The cells should exhibit a long service life during operation at temperatures of more than 100° C.
The individual cells should exhibit a consistent or improved performance at temperatures of more than 100° C. over a long period of time.
In this connection, the fuel cells should have a high open circuit voltage as well as a low gas crossover after a long operating time.
It should be possible to employ the fuel cells in particular at operating temperatures of more than 100° C. and without additional fuel gas humidification. The membrane electrode units should in particular be able to resist permanent or alternating pressure differences between anode and cathode.
Furthermore, it was consequently an object of the present invention to make available a membrane electrode unit which can be produced in an easy way and inexpensive. To this end, in particular, as little as possible of expensive materials should be employed.
In particular, the fuel cell should have, even after a long period of time, a high voltage and it should be possible to operate it with a low stoichiometry.
In particular, the MEU should be robust to different operating conditions (T, p, geometry, etc.) to increase the reliability in general.
Furthermore, expensive precious metal, in particular platinum metals should be utilised in a very efficient manner.

These objects are solved through membrane electrode units with all the features of claim 1.

Accordingly, the object of the present invention is a membrane electrode unit having two gas diffusion layers, each contacted with a catalyst layer, which are separated by a polymer electrolyte membrane, wherein the polymer electrolyte membrane has an inner area which is contacted with a catalyst layer, and an outer area which is not provided on the surface of a gas diffusion layer, characterized in that the thickness of the inner area of the membrane decreases over a period of 10 minutes by at least 5% at a pressure of 5 N/mm² and the thickness of the membrane in the outer area is greater than the thickness of the inner area of the membrane.

### Polymer Electrolyte Membranes

For the purposes of the present invention, suitable polymer electrolyte membranes are known per se.

In general, membranes are employed for this, which comprise acids, wherein the acids may be covalently bound to polymers. Furthermore, a flat material can be doped with an acid in order to form a suitable membrane.

The thickness of the inner area of the membrane decreases over a period of 10 minutes by at least 5%, preferably at least 10% and very particularly preferably at least 50% at a pressure of 5 N/mm². This property can be controlled in a known manner. These include in particular the degree of doping of a membrane doped with acid as well as additives which plasticize plastic material.

These membranes can, amongst other methods, be produced by swelling flat materials, for example a polymer film, with a fluid comprising aciduous compounds, or by manufacturing a mixture of polymers and aciduous compounds and the subsequent formation of a membrane by forming a flat structure and following solidification in order to form a membrane.

Polymers suitable for this purpose include, amongst others, polyolefines, such as poly(chloroprene), polyacetylene, polyphenylene, poly(ρ-xylylene), polyarylmethylene, polystyrene, polymethylstyrene, polyvinyl alcohol, polyvinyl acetate, polyvinyl ether, polyvinyl amine, poly(N-vinyl acetamide), polyvinyl imidazole, polyvinyl carbazole, polyvinyl pyrrolidone, polyvinyl pyridine, polyvinyl chloride, polyvinylidene chloride, polytetrafluoroethylene, polyhexafluoropropylene, copolymers of PTFE with hexafluoropropylene, with perfluoropropylvinyl ether, with trifluoronitrosomethane, with carbalkoxyperfluoroalkoxyvinyl ether, polychlorotrifluoroethylene, polyvinyl fluoride, polyvinylidene fluoride, polyacrolein, polyacrylamide, polyacrylonitrile, polycyanoacrylates, polymethacrylimide, cycloolefinic copolymers, in particular of norbornenes;

polymers having C—O bonds in the backbone, for example polyacetal, polyoxymethylene, polyether, polypropylene oxide, polyepichlorohydrin, polytetrahydrofuran, polyphenylene oxide, polyether ketone, polyester, in particular polyhydroxyacetic acid, polyethyleneterephthalate, polybutyleneterephthalate, polyhydroxybenzoate, polyhydroxypropionic acid, polypivalolacton, polycaprolacton, polymalonic acid, polycarbonate;
polymeric C—S-bonds in the backbone, for example, polysulphide ether, polyphenylenesulphide, polysulphones, polyethersulphone;
polymeric C—N bonds in the backbone, for example polyimines, polyisocyanides, polyetherimine, polyetherimides, polyaniline, polyaramides, polyamides, polyhydrazides, polyurethanes, polyimides, polyazoles, polyazole ether ketone, polyazines;
liquid crystalline polymers, in particular Vectra, as well as
inorganic polymers, such as polysilanes, polycarbosilanes, polysiloxanes, polysilicic acid, polysilicates, silicons, polyphosphazenes and polythiazyl.

Preferred herein are alkaline polymers, wherein this particularly applies to membranes doped with acids. Almost all known polymer membranes that are able to transport the protons come into consideration as alkaline polymer membranes doped with acid. Here, acids are preferred which are able to transport the protons without additional water, for example by means of the so-called Grotthus mechanism.

As alkaline polymer within the context of the present invention, preferably an alkaline polymer with at least one nitrogen atom in a repeating unit is used.

According to a preferred embodiment, the repeating unit in the alkaline polymer contains an aromatic ring with at least one nitrogen atom. The aromatic ring is preferably a five- to six-membered ring with one to three nitrogen atoms which can be fused to another ring, in particular another aromatic ring.

According to one particular aspect of the present invention, use is made of high-temperature-stable polymers which contain at least one nitrogen, oxygen and/or sulphur atom in one or in different repeating units.

Within the context of the present invention, a high-temperature-stable polymer is a polymer which, as polymer electrolyte, can be operated over the long term in a fuel cell at temperatures above 120° C. Over the long term means that a membrane according to the invention can be operated for at least 100 hours, preferably at least 500 hours, at a temperature of at least 80° C., preferably at least 120° C., particularly preferably at least 160° C., without the performance being decreased by more than 50%, based on the initial performance, which can be measured according to the method described in WO 01/18894 A2.

The abovementioned polymers can be used individually or as a mixture (blend). Here, preference is given in particular to blends which contain polyazoles and/or polysulphones. In this context, the preferred blend components are polyethersulphone, polyether ketone, and polymers modified with sulphonic acid groups, as described in the German patent application no. 10052242.4 and no. 10245451.8. By using blends, the mechanical properties can be improved and the material costs can be reduced.

Polyazoles constitute a particularly preferred group of alkaline polymers. An alkaline polymer based on polyazole contains recurring azole units of the general formula (I) and/or (II) and/or (III) and/or (IV) and/or (V) and/or (VI) and/or (VII) and/or (VIII) and/or (IX) and/or (X) and/or (XI) and/or (XII) and/or (XIII) and/or (XIV) and/or (XV) and/or (XVI) and/or (XVII) and/or (XVIII) and/or (XIX) and/or (XX) and/or (XXI) and/or (XXII)

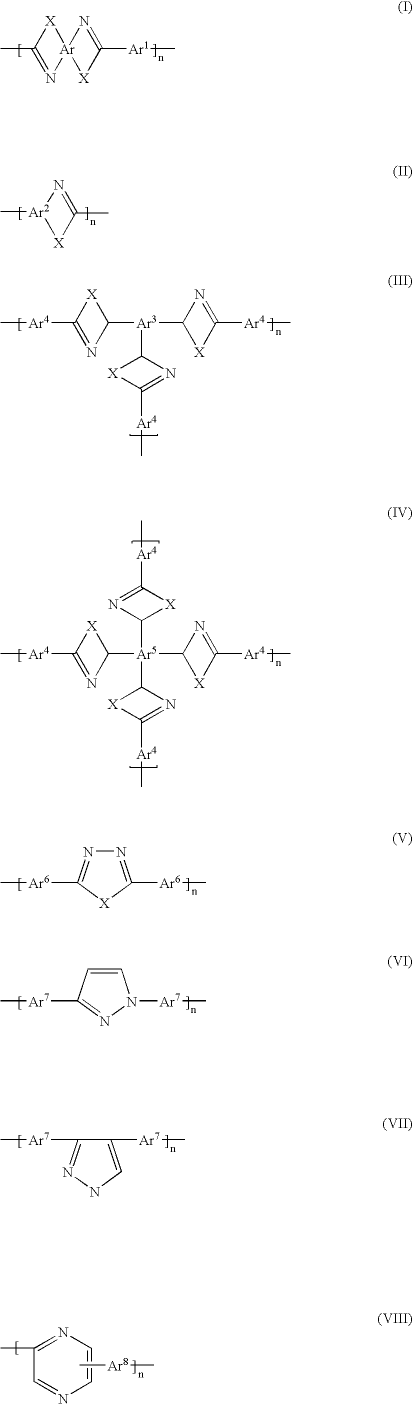

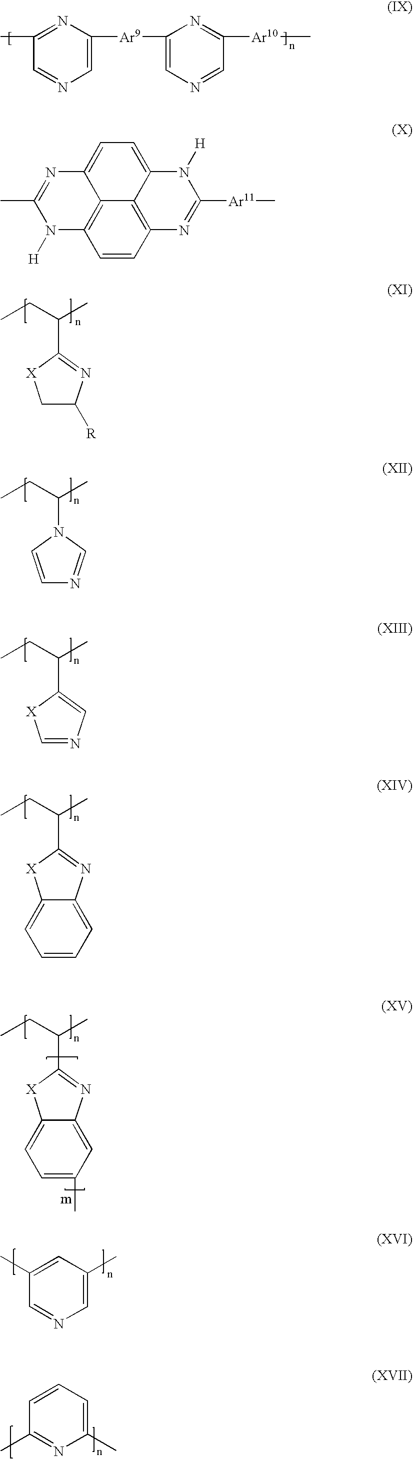

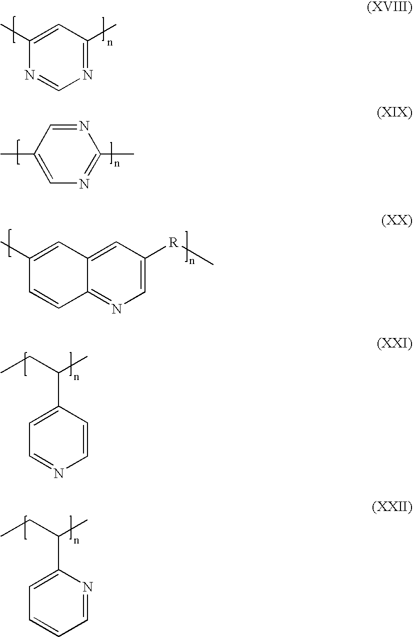

wherein
Ar are identical or different and represent a tetracovalent aromatic or heteroaromatic group which can be mononuclear or polynuclear,
Ar¹ are identical or different and represent a bicovalent aromatic or heteroaromatic group which can be mononuclear or polynuclear,
Ar² are identical or different and represent a bicovalent or tricovalent aromatic or heteroaromatic group which can be mononuclear or polynuclear,
Ar³ are identical or different and represent a tricovalent aromatic or heteroaromatic group which can be mononuclear or polynuclear,
Ar⁴ are identical or different and represent a tricovalent aromatic or heteroaromatic group which can be mononuclear or polynuclear,
Ar⁵ are identical or different and represent a tetracovalent aromatic or heteroaromatic group which can be mononuclear or polynuclear,
Ar⁶ are identical or different and represent a bicovalent aromatic or heteroaromatic group which can be mononuclear or polynuclear,
Ar⁷ are identical or different and represent a bicovalent aromatic or heteroaromatic group which can be mononuclear or polynuclear,
Ar⁸ are identical or different and represent a tricovalent aromatic or heteroaromatic group which can be mononuclear or polynuclear,
Ar⁹ are identical or different and represent a bicovalent or tricovalent or tetracovalent aromatic or heteroaromatic group which can be mononuclear or polynuclear,
Ar¹⁰ are identical or different and represent a bicovalent or tricovalent aromatic or heteroaromatic group which can be mononuclear or polynuclear,
Ar¹¹ are identical or different and represent a bicovalent aromatic or heteroaromatic group which can be mononuclear or polynuclear,
X are identical or different and represent oxygen, sulphur or an amino group which carries a hydrogen atom, a group having 1-20 carbon atoms, preferably a branched or unbranched alkyl or alkoxy group, or an aryl group as a further radical,
R are identical or different and represent hydrogen, an alkyl group and an aromatic group, and
n, m are each an integer greater than or equal to 10, preferably greater or equal to 100.

Preferred aromatic or heteroaromatic groups are derived from benzene, naphthalene, biphenyl, diphenyl ether, diphenylmethane, diphenyldimethylmethane, bisphenone, diphenylsulphone, quinoline, pyridine, bipyridine, pyridazine, pyrimidines, pyrazine, triazine, tetrazine, pyrrole, pyrazole, anthracene, benzopyrrole, benzotriazole, benzooxathiadiazole, benzooxadiazole, benzopyridine, benzopyrazine, benzopyrazidine, benzopyrimidine, benzotriazine, indolizine, quinolizine, pyridopyridine, imidazopyrimidine, pyrazinopyrimidine, carbazole, aziridine, phenazine, benzoquinoline, phenoxazine, phenothiazine, acridizine, benzopteridine, phenanthroline and phenanthrene which optionally also can be substituted.

In this case, Ar¹, Ar⁴, Ar⁶, Ar⁷, Ar⁸, Ar⁹, Ar¹⁰, Ar¹¹ can have any substitution pattern, in the case of phenylene, for example, Ar¹, Ar⁴, Ar⁶, Ar⁷, Ar⁸, Ar⁹, Ar¹⁰, Ar¹¹ can be ortho-, meta- and para-phenylene. Particularly preferred groups are derived from benzene and biphenylene, which may also be substituted.

Preferred alkyl groups are short-chain alkyl groups having 1 to 4 carbon atoms, e.g. methyl, ethyl, n- or i-propyl and t-butyl groups.

Preferred aromatic groups are phenyl or naphthyl groups. The alkyl groups and the aromatic groups can be substituted.

Preferred substituents are halogen atoms, e.g. fluorine, amino groups, hydroxy groups or short-chain alkyl groups, e.g. methyl or ethyl groups.

Polyazoles having recurring units of the formula (I) are preferred wherein the radicals X within one recurring unit are identical.

The polyazoles can in principle also have different recurring units wherein their radicals X are different, for example. It is preferable, however, that a recurring unit has only identical radicals X.

Further preferred polyazole polymers are polyimidazoles, polybenzothiazoles, polybenzoxazoles, polyoxadiazoles, polyquinoxalines, polythiadiazoles, poly(pyridines), poly(pyrimidines) and poly(tetrazapyrenes).

In another embodiment of the present invention, the polymer containing recurring azole units is a copolymer or a blend which contains at least two units of the formulae (I) to (XXII) which differ from one another. The polymers can be in the form of block copolymers (diblock, triblock), random copolymers, periodic copolymers and/or alternating polymers.

In a particularly preferred embodiment of the present invention, the polymer containing recurring azole units is a polyazole which only contains units of the formulae (I) and/or (II).

The number of recurring azole units in the polymer is preferably an integer greater than or equal to 10. Particularly preferred polymers contain at least 100 recurring azole units.

Within the scope of the present invention, polymers containing recurring benzimidazole units are preferred. Some examples of the most appropriate polymers containing recurring benzimidazole units are represented by the following formulae:

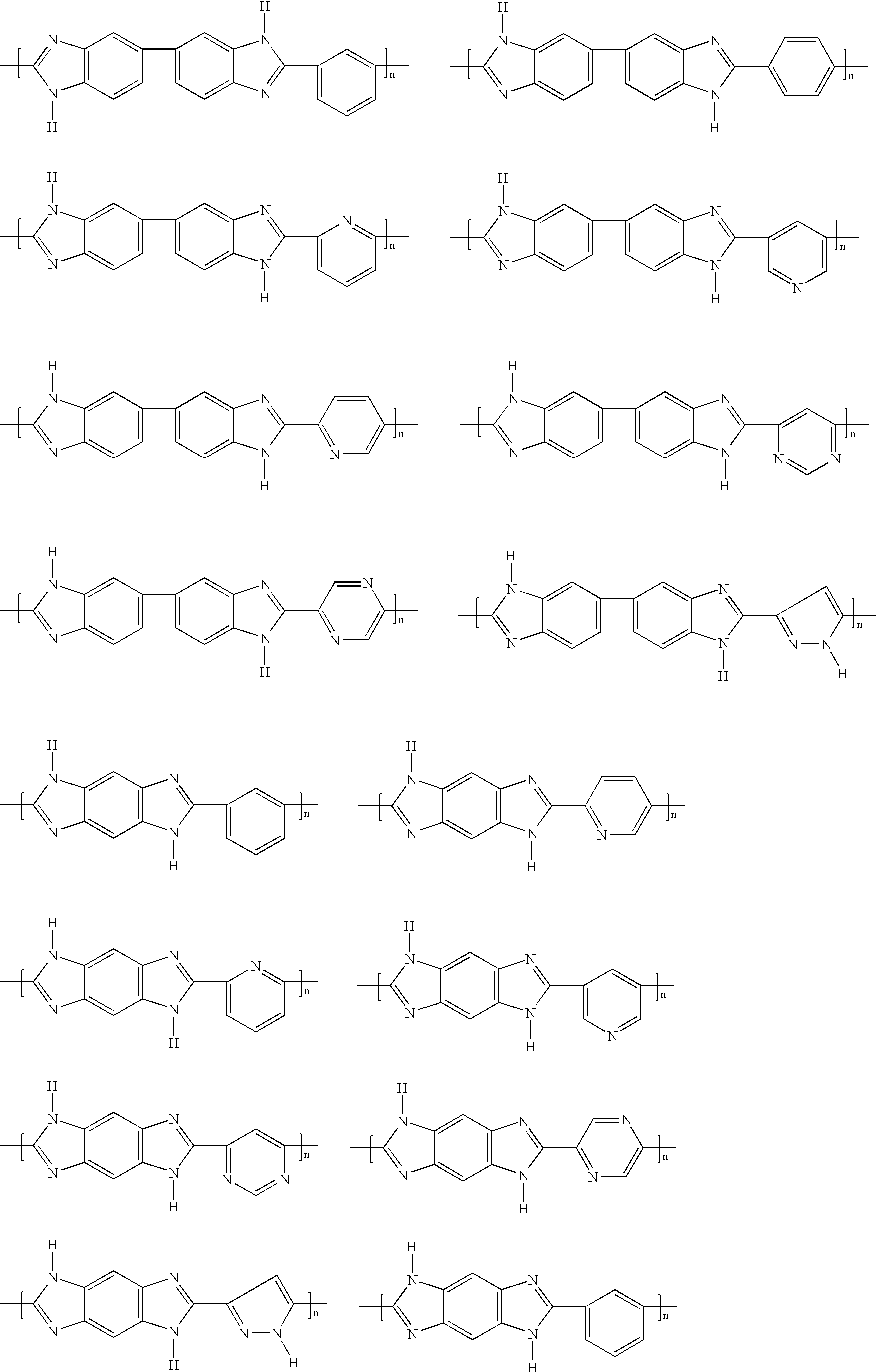

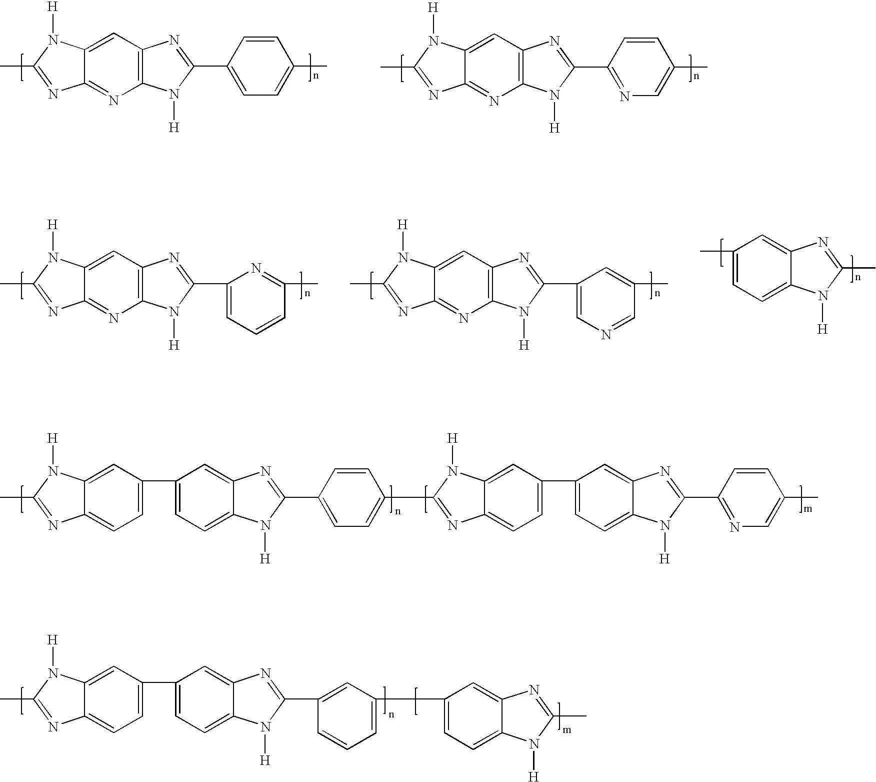

where n and m are each an integer greater than or equal to 10, preferably greater than or equal to 100.

The polyazoles used, in particular, however, the polybenzimidazoles are characterized by a high molecular weight. Measured as the intrinsic viscosity, this is preferably at least 0.2 dl/g, preferably 0.8 to 10 dl/g, in particular 1 to 10 dl/g.

The preparation of such polyazoles is known, wherein one or more aromatic tetra-amino compounds are reacted in the melt with one or more aromatic carboxylic acids or the esters thereof which contain at least two acid groups per carboxylic acid monomer, to form a prepolymer. The resulting prepolymer solidifies in the reactor and is then comminuted mechanically. The pulverulent prepolymer is usually end-polymerised in a solid-phase polymerisation at temperatures of up to 400° C.

The preferred aromatic carboxylic acids are, amongst others, dicarboxylic acids and tricarboxylic acids and tetracarboxylic acids or their esters or their anhydrides or their acid chlorides. The term aromatic carboxylic acids likewise also comprises heteroaromatic carboxylic acids.

Preferably, the aromatic dicarboxylic acids are isophthalic acid, terephthalic acid, phthalic acid, 5-hydroxyisophthalic acid, 4-hydroxyisophthalic acid, 2-hydroxyterephthalic acid, 5-aminoisophthalic acid, 5-N,N-dimethylaminoisophthalic acid, 5-N,N-diethylaminoisophthalic acid, 2,5-dihydroxyterephthalic acid, 2,6-dihydroxyisophthalic acid, 4,6-dihydroxyisophthalic acid, 2,3-dihydroxyphthalic acid, 2,4-dihydroxyphthalic acid, 3,4-dihydroxyphthalic acid, 3-fluorophthalic acid, 5-fluoroisophthalic acid, 2-fluoroterephthalic acid, tetrafluorophthalic acid, tetrafluoroisophthalic acid, tetrafluoroterephthalic acid, 1,4-naphthalenedicarboxylic acid, 1,5-naphthalenedicarboxylic acid, 2,6-naphthalenedicarboxylic acid, 2,7-naphthalenedicarboxylic acid, diphenic acid, 1,8-dihydroxynaphthalene-3,6-dicarboxylic acid, diphenyl ether-4,4′-dicarboxylic acid, benzophenone-4,4′-dicarboxylic acid, diphenylsulphone-4,4′-dicarboxylic acid, biphenyl-4,4′-dicarboxylic acid, 4-trifluoromethylphthalic acid, 2,2-bis-(4-carboxyphenyl)hexafluoropropane, 4,4′-stilbenedicarboxylic acid, 4-carboxycinnamic acid or their C1-C20 alkyl esters or C5-C12 aryl esters or their acid anhydrides or their acid chlorides.

The aromatic tricarboxylic acids, tetracarboxylic acids or their C1-C20 alkyl esters or C5-C12 aryl esters or their acid anhydrides or their acid chlorides are preferably 1,3,5-benzenetricarboxylic acid (trimesic acid), 1,2,4-benzenetricarboxylic acid (trimellitic acid), (2-carboxyphenyl)iminodiacetic acid, 3,5,3′-biphenyltricarboxylic acid or 3,5,4′-biphenyltricarboxylic acid.

The aromatic tetracarboxylic acids or their C1-C20 alkyl esters or C5-C12 aryl esters or their acid anhydrides or their acid chlorides are preferably 3,5,3′,5′-biphenyltetracarboxylic acid, 1,2,4,5-benzenetetracarboxylic acid, benzophenonetetracarboxylic acid, 3,3′,4,4′-biphenyltetracarboxylic acid, 2,2′,3,3′-biphenyltetracarboxylic acid, 1,2,5,6-naphthalenetetracarboxylic acid or 1,4,5,8-naphthalenetetracarboxylic acid.

The heteroaromatic carboxylic acids are heteroaromatic dicarboxylic acids and tricarboxylic acids and tetracarboxylic acids or their esters or their anhydrides. Heteroaromatic carboxylic acids are understood to mean aromatic systems which contain at least one nitrogen, oxygen, sulphur or phosphor atom in the aromatic group. Preferably, it is pyridine-2,5-dicarboxylic acid, pyridine-3,5-dicarboxylic acid, pyridine-2,6-dicarboxylic acid, pyridine-2,4-dicarboxylic acid, 4-phenyl-2,5-pyridinedicarboxylic acid, 3,5-pyrazoledicarboxylic acid, 2,6-pyrimidinedicarboxylic acid, 2,5-pyrazinedicarboxylic acid, 2,4,6-pyridinetricarboxylic acid or benzimidazole-5,6-dicarboxylic acid and their C1-C20 alkyl esters or C5-C12 aryl esters or their acid anhydrides or their acid chlorides.

The content of tricarboxylic acids or tetracarboxylic acids (based on dicarboxylic acid used) is between 0 and 30 mol-%, preferably 0.1 and 20 mol-%, in particular 0.5 and 10 mol-%.

The aromatic and heteroaromatic diaminocarboxylic acids used are preferably diaminobenzoic acid and its monohydrochloride or dihydrochloride derivatives.

Preferably, mixtures of at least 2 different aromatic carboxylic acids are used. Particularly preferably, mixtures are used which also contain heteroaromatic carboxylic acids additional to aromatic carboxylic acids. The mixing ratio of aromatic carboxylic acids to heteroaromatic carboxylic acids is from 1:99 to 99:1, preferably 1:50 to 50:1.

These mixtures are in particular mixtures of N-heteroaromatic dicarboxylic acids and aromatic dicarboxylic acids. Non-limiting examples of these are isophthalic acid, terephthalic acid, phthalic acid, 2,5-dihydroxyterephthalic acid, 2,6-dihydroxyisophthalic acid, 4,6-dihydroxyisophthalic acid, 2,3-dihydroxyphthalic acid, 2,4-dihydroxyphthalic acid, 3,4-dihydroxyphthalic acid, 1,4-naphthalenedicarboxylic acid, 1,5-naphthalenedicarboxylic acid, 2,6-naphthalenedicarboxylic acid, 2,7-naphthalenedicarboxylic acid, diphenic acid, 1,8-dihydroxynaphthalene-3,6-dicarboxylic acid, diphenyl ether-4,4′-dicarboxylic acid, benzophenone-4,4′-dicarboxylic acid, diphenylsulphone-4,4′-dicarboxylic acid, biphenyl-4,4′-dicarboxylic acid, 4-trifluoromethylphthalic acid, pyridine-2,5-dicarboxylic acid, pyridine-3,5-dicarboxylic acid, pyridine-2,6-dicarboxylic acid, pyridine-2,4-dicarboxylic acid, 4-phenyl-2,5-pyridinedicarboxylic acid, 3,5-pyrazoledicarboxylic acid, 2,6-pyrimidinedicarboxylic acid, 2,5-pyrazinedicarboxylic acid.

The preferred aromatic tetraamino compounds include, amongst others, 3,3′,4,4′-tetraaminobiphenyl, 2,3,5,6-tetraaminopyridine, 1,2,4,5-tetraaminobenzene, 3,3′,4,4′-tetraaminodiphenyl sulphone, 3,3′,4,4′-tetraaminodiphenyl ether, 3,3′,4,4′-tetraaminobenzophenone, 3,3′,4,4′-tetraaminodiphenylmethane and 3,3′,4,4′-tetraaminodiphenyldimethylmethane as well as their salts, in particular their monohydrochloride, dihydrochloride, trihydrochloride and tetrahydrochloride derivatives.

Preferred polybenzimidazoles are commercially available under the trade name ®Celazole from Celanese AG.

Preferred polymers include polysulphones, in particular polysulphone having aromatic and/or heteroaromatic groups in the backbone. According to a particular aspect of the present invention, preferred polysulphones and polyethersulphones have a melt volume rate MVR 300/21.6 of less than or equal to 40 cm³/10 min, in particular less than or equal to 30 cm³/10 min and particularly preferably less than or equal to 20 cm³/10 min, measured in accordance with ISO 1133. In this connection, polysulphones with a Vicat softening point VST/A/50 of from 180° C. to 230° C. are preferred. In yet another preferred embodiment of the present invention, the number average of the molecular weight of the polysulphones is greater than 30,000 g/mol.

The polymers based on polysulphone include in particular polymers having recurring units with linking sulphone groups according to the general formulae A, B, C, D, E, F and/or G:
—O—R—SO₂—R— (A)
—O—R—SO₂—R—O—R— (B)
—O—R—SO₂—R—O—R—R— (C)

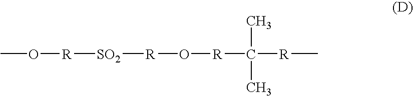

—O—R—SO₂—R—R—SO₂—R— (E)
—O—R—SO₂—R—R—SO₂—R—O—R—SO₂—] (F)
O—R—SO₂—RSO₂—R (G),
   wherein the radicals R, independently of another, identical or different, represent aromatic or heteroaromatic groups, these radicals having been explained in detail above. These include in particular 1,2-phenylene, 1,3-phenylene, 1,4-phenylene, 4,4′-biphenyl, pyridine, quinoline, naphthalene, phenanthrene.

The polysulphones preferred within the scope of the present invention include homopolymers and copolymers, for example random copolymers. Particularly preferred polysulphones comprise recurring units of the formulae H to N:

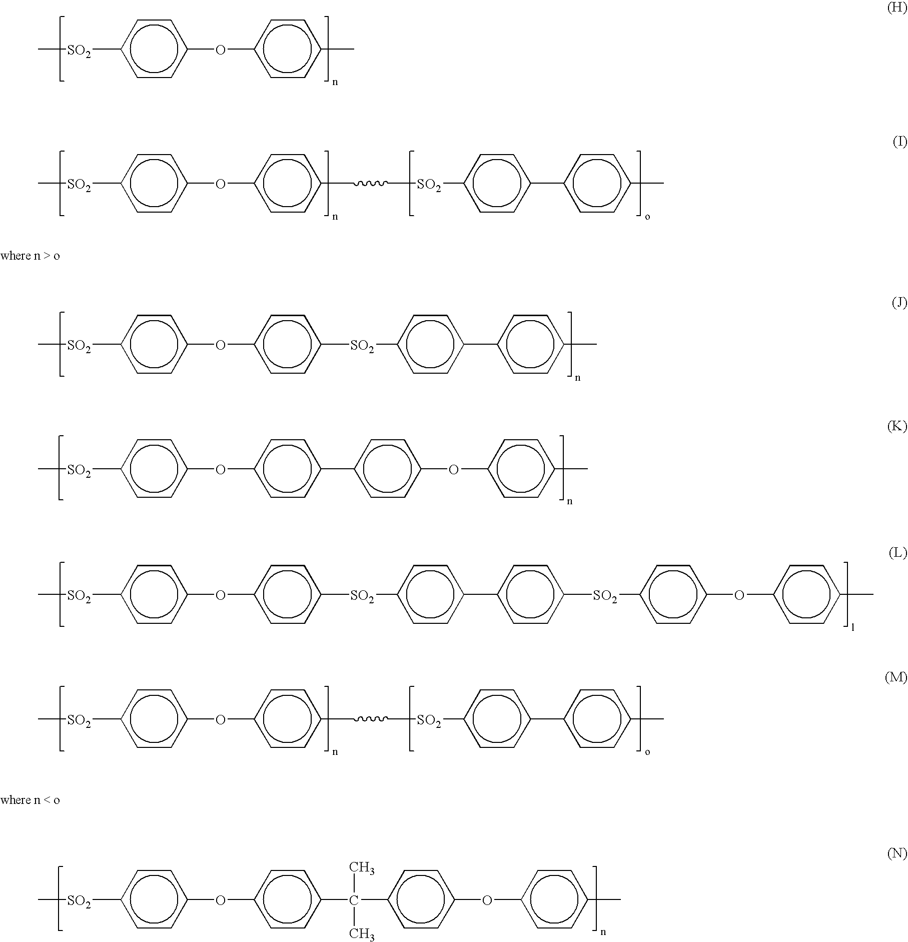

The previously described polysulphones can be obtained commercially under the trade names ®Victrex 200 P, ®Victrex 720 P, ®Ultrason E, ®Ultrason S, ®Mindel, ®Radel A, ®Radel R, ®Victrex HTA, ®Astrel and ®Udel.

Furthermore, polyether ketones, polyether ketone ketones, polyether ether ketones, polyether ether ketone ketones and polyaryl ketones are particularly preferred. These high-performance polymers are known per se and can be obtained commercially under the trade names Victrex® PEEK™, ®Hostatec, ®Kadel.

To produce polymer films, a polymer, preferably a polyazole can be dissolved in an additional step in polar, aprotic solvents such as dimethylacetamide (DMAc) and a film is produced by means of classical methods.

In order to remove residues of solvents, the film thus obtained can be treated with a washing liquid as is described in the German patent application No. 10109829.4. Due to the cleaning of the polyazole film to remove residues of solvents described in the German patent application, the mechanical properties of the film are surprisingly improved. These properties include in particular the modulus of elasticity, the tear strength and the break strength of the film.

Additionally, the polymer film can have further modifications, for example by cross-linking, as described in the German patent application No. 1010752.8 or in WO 00/44816. In a preferred embodiment, the polymer film used consisting of an alkaline polymer and at least one blend component additionally contains a cross-linking agent, as described in the German patent application No. 10140147.7.

The thickness of the polyazole films can be within wide ranges. Preferably, the thickness of the polyazole film before its doping with acid is generally in the range of 5 μm to 2000 μm, particularly preferably in the range of 10 μm to 1000 μm; however, this should not constitute a limitation.

In order to achieve proton conductivity, these films are doped with an acid. In this context, acids include all known Lewis und Brønsted acids, preferably inorganic Lewis und Brønsted acids.

Furthermore, the application of polyacids is also possible, in particular isopolyacids and heteropolyacids, as well as mixtures of different acids. Here, heteropolyacids within the context of the invention refer to inorganic polyacids with at least two different central atoms formed of weak, multibasic oxygen acids of a metal (preferably Cr, Mo, V, W) and a non-metal (preferably As, I, P, Se, Si, Te) as partial mixed anhydrides. These include, amongst others, 12-molybdophosphoric acid and 12-wolframophosphoric acid.

The degree of doping can influence the conductivity of the polyazole film. The conductivity increases with rising concentration of the doping substance until a maximum value is reached. According to the invention, the degree of doping is given as mole of acid per mole of repeating unit of the polymer. Within the scope of the present invention, a degree of doping between 3 and 50, in particular between 5 and 40 is preferred.

Particularly preferred doping substances are phosphoric and sulphuric acids, or compounds releasing these acids for example during hydrolysis, respectively. A very particularly preferred doping substance is phosphoric acid (H₃PO₄). Here, highly concentrated acids are generally used. According to a particular aspect of the present invention, the concentration of the phosphoric acid is at least 50% by weight, in particular at least 80% by weight, based on the weight of the doping substance.

Furthermore, proton-conductive membranes can be obtained by a method comprising the steps:
I) dissolving the polymers, particularly polyazoles in phosphoric acid
II) heating the solution obtainable in accordance with step I) under inert gas to temperatures of up to 400° C.,
III) forming a membrane using the solution of the polymer in accordance with step II) on a support and
IV) treatment of the membrane formed in step ill) until it is self-supporting.

Furthermore, doped polyazole films can be obtained by a method comprising the steps:
A) mixing one or more aromatic tetraamino compounds with one or more aromatic carboxylic acids or their esters, which contain at least two acid groups per carboxylic acid monomer, or mixing one or more aromatic and/or heteroaromatic diaminocarboxylic acids in polyphosphoric acid with formation of a solution and/or dispersion,
B) applying a layer using the mixture in accordance with step A) to a support or to an electrode,
C) heating the flat structure/layer obtainable in accordance with step B) under inert gas to temperatures of up to 350° C., preferably up to 280° C., with formation of the polyazole polymer,
D) treatment of the membrane formed in step C) (until it is self-supporting).

The aromatic or heteroaromatic carboxylic acid and tetraamino compounds to be employed in step A) have been described above.

The polyphosphoric acid used in step A) is a customary polyphosphoric acid as is available, for example, from Riedel-de Haen. The polyphosphoric acids Hₙ₊₂PₙO₃ₙ₊₁ (n>1) usually have a concentration of at least 83%, calculated as P₂O₅ (by acidimetry). Instead of a solution of the monomers, it is also possible to produce a dispersion/suspension.

The mixture produced in step A) has a weight ratio of polyphosphoric acid to the sum of all monomers of from 1:10,000 to 10,000:1, preferably 1:1000 to 1000:1, in particular 1:100 to 100:1.

The layer formation in accordance with step B) is performed by means of measures known per se (pouring, spraying, application with a doctor blade) which are known from the prior art of polymer film production. Every support that is considered as inert under the conditions is suitable as a support. To adjust the viscosity, phosphoric acid (conc. phosphoric acid, 85%) can be added to the solution, where required. Through this, the viscosity can be adjusted to the desired value and the formation of the membrane be facilitated.

The layer produced in accordance with step B) has a thickness of 20 to 4000 μm, preferably of 30 to 3500 μm, in particular of 50 to 3000 μm.

If the mixture in accordance with step A) also contains tricarboxylic acids or tetracarboxylic acid, branching/cross-linking of the formed polymer is achieved therewith. This contributes to an improvement in the mechanical property. The treatment of the polymer layer produced in accordance with step C) in the presence of moisture at temperatures and for a period of time until the layer exhibits a sufficient strength for use in fuel cells. The treatment can be effected to the extent that the membrane is self-supporting so that it can be detached from the support without any damage.

The flat structure obtained in step B) is, in accordance with step C), heated to a temperature of up to 350° C., preferably up to 280° C. and particularly preferably in the range of 200° C. to 250° C. The inert gases to be employed in step C) are known to those in the field. Particularly nitrogen as well as noble gases, such as neon, argon and helium belong to this group.

In a variant of the method, the formation of oligomers and/or polymers can already be brought about by heating the mixture resulting from step A) to a temperature of up to 350° C., preferably up to 280° C. Depending on the selected temperature and duration, it is then possible to dispense partly or fully with the heating in step C). This variant is also object of the present invention.

The treatment of the membrane in step D) is performed at temperatures of more than 0° C. and less than 150° C., preferably at temperatures between 10° C. and 120° C., in particular between room temperature (20° C.) and 90° C., in the presence of moisture or water and/or steam and/or water-containing phosphoric acid of up to 85%. The treatment is preferably performed at normal pressure, but can also be carried out with action of pressure. It is essential that the treatment takes place in the presence of sufficient moisture whereby the polyphosphoric acid present contributes to the solidification of the membrane by means of partial hydrolysis with formation of low molecular weight polyphosphoric acid and/or phosphoric acid.

The hydrolysis fluid may be a solution, wherein the fluid may also contain suspended and/or dispersed constituents. The viscosity of the hydrolysis fluid can be within wide ranges wherein an addition of solvents or an increase in temperature can take place to adjust the viscosity. Preferably, the dynamic viscosity is in the range of 0.1 to 10000 mPa*s, in particular 0.2 to 2000 mPa*s, wherein these values can be measured in accordance with DIN 53015, for example.

The treatment according to step D) can take place with any known method. The membrane obtained in step C) can, for example, be immersed in a fluid bath. Furthermore, the hydrolysis fluid can be sprayed onto the membrane. Additionally, the hydrolysis fluid can be poured onto the membrane. The latter methods have the advantage that the concentration of the acid in the hydrolysis fluid remains constant during the hydrolysis. However, the first method is often cheaper in practice.

The oxo acids of phosphorus and/or sulphur include in particular phosphinic acid, phosphonic acid, phosphoric acid, hypodiphosphonic acid, hypodiphosphoric acid, oligophosphoric acids, sulphurous acid, disulphurous acid and/or sulphuric acid. These acids can be used individually or as a mixture.

Furthermore, the oxo acids of phosphorus and/or sulphur comprise monomers that can be processed by free-radical polymerisation and comprise phosphonic acid and/or sulphonic acid groups.

Monomers comprising phosphonic acid groups are known in professional circles. These are compounds having at least one carbon-carbon double bond and at least one phosphonic acid group. Preferably, the two carbon atoms forming the carbon-carbon double bond have at least two, preferably 3, bonds to groups which lead to minor steric hindrance of the double bond. These groups include, amongst others, hydrogen atoms and halogen atoms, in particular fluorine atoms. Within the context of the present invention, the polymer containing phosphonic acid groups results from the polymerisation product which is obtained by polymerising the monomer containing phosphonic acid groups alone or with other monomers and/or crosslinkers.

The monomer containing phosphonic acid groups may comprise one, two, three or more carbon-carbon double bonds. Furthermore, the monomer comprising phosphonic acid groups can contain one, two, three or more phosphonic acid groups.

Generally, the monomer comprising phosphonic acid groups contains 2 to 20, preferably 2 to 10, carbon atoms.

The monomer comprising phosphonic acid groups is preferably a compound of the formula

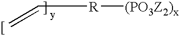

wherein
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned radicals themselves can be substituted with halogen, —OH, COOZ, —CN, NZ₂,
Z independently of one another is hydrogen, a C1-C15 alkyl group, a C1-C15 alkoxy group, an ethylenoxy group or a C5-C20 aryl or heteroaryl group, wherein the above radicals may in turn be substituted by halogen, —OH, —CN, and
x represents an integer 1, 2, 3, 4, 5, 6, 7, 8, 9 or 10
y represents an integer 1, 2, 3, 4, 5, 6, 7, 8, 9 or 10
   and/or of the formula

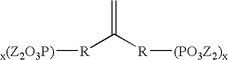

wherein
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned radicals themselves can be substituted with halogen, —OH, COOZ, —CN, NZ₂,
Z independently of one another is hydrogen, a C1-C15 alkyl group, a C1-C15 alkoxy group, an ethylenoxy group or a C5-C20 aryl or heteroaryl group, wherein the above radicals may in turn be substituted by halogen, —OH, —CN, and
x represents an integer 1, 2, 3, 4, 5, 6, 7, 8, 9 or 10
   and/or of the formula

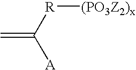

wherein
A is a group of the formula COOR², CN, CONR²₂, OR² and/or R²,
   in which R² is hydrogen, a C1-C15 alkyl group, a C1-C15 alkoxy group, an ethylenoxy group or a C5-C20 aryl or heteroaryl group, wherein the above radicals may in turn be substituted by halogen, —OH, COOZ, —CN, NZ₂,
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned radicals themselves can be substituted with halogen, —OH, COOZ, —CN, NZ₂,
Z independently of one another is hydrogen, a C1-C15 alkyl group, a C1-C15 alkoxy group, an ethylenoxy group or a C5-C20 aryl or heteroaryl group, wherein the above radicals may in turn be substituted by halogen, —OH, —CN, and
x is an integer 1, 2, 3, 4, 5, 6, 7, 8, 9 or 10.

Preferred monomers comprising phosphonic acid groups include, amongst others, alkenes having phosphonic acid groups, such as ethenephosphonic acid, propenephosphonic acid, butenephosphonic acid; acrylic acid and/or methacrylic acid compounds having phosphonic acid groups, such as for example 2-phosphonomethyl acrylic acid, 2-phosphonomethyl methacrylic acid, 2-phosphonomethyl acrylamide and 2-phosphonomethyl methacrylamide.

With particular preference, use is made of commercially available vinylphosphonic acid (ethenephosphonic acid), as obtainable for example from Aldrich or Clariant GmbH. A preferred vinylphosphonic acid has a purity of more than 70%, in particular 90% and particularly preferably a purity of more than 97%.

The monomers comprising phosphonic acid groups can furthermore be employed in the form of derivatives, which subsequently can be converted to the acid, wherein the conversion to the acid can also take place in the polymerised state. These derivatives include in particular the salts, the esters, the amides and the halides of the monomers comprising phosphonic acid groups.

Furthermore, the monomers comprising phosphonic acid groups can also be introduced onto and into the membrane after the hydrolysis. This can be performed by means of measures known per se (e.g., spraying, immersing) which are known from the prior art.

According to a particular aspect of the present invention, the ratio of the weight of the sum of phosphoric acid, polyphosphoric acid and the hydrolysis products of the polyphosphoric acid to the weight of the monomers that can be processed by free-radical polymerisation, for example the monomers comprising phosphonic acid groups, is preferably greater than or equal to 1:2, in particular greater than or equal to 1:1 and particularly preferably greater than or equal to 2:1.

Preferably, the ratio of the weight of the sum of phosphoric acid, polyphosphoric acid and the hydrolysis products of the polyphosphoric acid to the weight of the monomers that can be processed by free-radical polymerisation is in the range of 1000:1 to 3:1, in particular 100:1 to 5:1 and particularly preferably 50:1 to 10:1.

This ratio can easily be determined by means of customary methods in which, in many cases, the phosphoric acid, polyphosphoric acid and their hydrolysis products can be washed out of the membrane. Through this, the weight of the polyphosphoric acid and its hydrolysis products can be obtained after the completed hydrolysis to phosphoric acid. In general, this also applies to the monomers that can be processed by free-radical polymerisation.

Monomers containing sulphonic acid groups are known to those in the field. These are compounds having at least one carbon-carbon double bond and at least one sulphonic acid group. Preferably, the two carbon atoms forming the carbon-carbon double bond have at least two, preferably 3, bonds to groups which lead to minor steric hindrance of the double bond. These groups include, amongst others, hydrogen atoms and halogen atoms, in particular fluorine atoms. Within the context of the present invention, the polymer containing sulphonic acid groups results from the polymerisation product which is obtained by polymerising the monomer containing sulphonic acid groups alone or with other monomers and/or crosslinkers.

The monomer containing sulphonic acid groups may comprise one, two, three or more carbon-carbon double bonds. Furthermore, the monomer comprising sulphonic acid groups can contain one, two, three or more sulphonic acid groups.

Generally, the monomer comprising sulphonic acid groups contains 2 to 20, preferably 2 to 10, carbon atoms.

The monomers containing sulphonic acid groups are preferably compounds of the formula

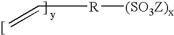

wherein
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned radicals themselves can be substituted with halogen, —OH, COOZ, —CN, NZ₂,
Z independently of one another is hydrogen, a C1-C15 alkyl group, a C1-C15 alkoxy group, an ethylenoxy group or a C5-C20 aryl or heteroaryl group, wherein the above radicals may in turn be substituted by halogen, —OH, —CN, and
x represents an integer 1, 2, 3, 4, 5, 6, 7, 8, 9 or 10
y represents an integer 1, 2, 3, 4, 5, 6, 7, 8, 9 or 10
   and/or of the formula

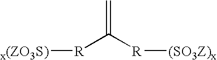

wherein
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned radicals themselves can be substituted with halogen, —OH, COOZ, —CN, NZ₂,
Z independently of one another is hydrogen, a C1-C15 alkyl group, a C1-C15 alkoxy group, an ethylenoxy group or a C5-C20 aryl or heteroaryl group, wherein the above radicals may in turn be substituted by halogen, —OH, —CN, and
x represents an integer 1, 2, 3, 4, 5, 6, 7, 8, 9 or 10
   and/or of the formula

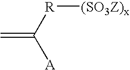

wherein
A is a group of the formula COOR², CN, CONR²₂, OR² and/or R²,
   in which R² is hydrogen, a C1-C15 alkyl group, a C1-C15 alkoxy group, an ethylenoxy group or a C5-C20 aryl or heteroaryl group, wherein the above radicals may in turn be substituted by halogen, —OH, COOZ, —CN, NZ₂,
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned radicals themselves can be substituted with halogen, —OH, COOZ, —CN, NZ₂,
Z independently of one another is hydrogen, a C1-C15 alkyl group, a C1-C15 alkoxy group, an ethylenoxy group or a C5-C20 aryl or heteroaryl group, wherein the above radicals may in turn be substituted by halogen, —OH, —CN, and
x is an integer 1, 2, 3, 4, 5, 6, 7, 8, 9 or 10.

Preferred monomers comprising sulphonic acid groups include, amongst others, alkenes having sulphonic acid groups, such as ethenesulphonic acid, propenesulphonic acid, butenesuiphonic acid; acrylic acid compounds and/or methacrylic acid compounds having sulphonic acid groups, such as for example 2-sulphonomethyl acrylic acid, 2-sulphonomethyl methacrylic acid, 2-sulphonomethyl acrylamide and 2-sulphonomethyl methacrylamide.

With particular preference, use is made of commercially available vinylsulphonic acid (ethenesulphonic acid), as obtainable for example from Aldrich or Clariant GmbH. A preferred vinylsulphonic acid has a purity of more than 70%, in particular 90% and particularly preferably a purity of more than 97%.

The monomers comprising sulphonic acid groups can furthermore be employed in the form of derivatives, which subsequently can be converted to the acid, wherein the conversion to the acid may also take place in the polymerised state. These derivatives include in particular the salts, esters, amides and halides of the monomers containing sulphonic acid groups.

Furthermore, the monomers comprising sulphonic acid groups can also be introduced onto and into the membrane after the hydrolysis. This can be performed by means of measures known per se (e.g., spraying, immersing) which are known from the prior art.

In another embodiment of the invention, monomers capable of cross-linking can be employed. These monomers can be added to the hydrolysis fluid. Furthermore, the monomers capable of cross-linking can also be applied to the membrane obtained after the hydrolysis.

The monomers capable of cross-linking are in particular compounds having at least 2 carbon-carbon double bonds. Preference is given to dienes, trienes, tetraenes, dimethylacrylates, trimethylacrylates, tetramethylacrylates, diacrylates, triacrylates, tetraacrylates.

Particular preference is given to dienes, trienes, tetraenes of the formula

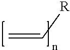

dimethylacrylates, trimethylacrylates, tetramethylacrylates of the formula

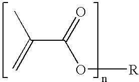

diacrylates, triacrylates, tetraacrylates of the formula

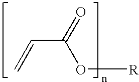

wherein
R represents a C1-C15 alkyl group, a C5-C20 aryl or heteroaryl group, NR′, —SO₂, PR′, Si(R′)₂, wherein the above-mentioned radicals themselves can be substituted,
R′ represent, independently of another, hydrogen, a C1-C15 alkyl group, a C1-C15 alkoxy group, a C5-C20 aryl or heteroaryl group, and
n is at least 2.

The substituents of the above-mentioned radical R are preferably halogen, hydroxyl, carboxy, carboxyl, carboxylester, nitriles, amines, silyl, siloxane radicals.

Particularly preferred crosslinkers are allyl methacrylate, ethylene glycol dimethacrylate, diethylene glycol dimethacrylate, triethylene glycol dimethacrylate, tetraethylene glycol dimethacrylate and polyethylene glycol dimethacrylate, 1,3-butanediol dimethacrylate, glycerol dimethacrylate, diurethane dimethacrylate, trimethylpropane trimethacrylate, epoxy acrylates, for example ebacryl, N′,N-methylenebisacrylamide, carbinol, butadiene, isoprene, chloroprene, divinylbenzene and/or bisphenol-A-dimethylacrylate. These compounds are commercially available from Sartomer Company Exton, Pa. under the designations CN-120, CN104 and CN-980, for example.

The use of cross-linking agents is optional, wherein these compounds can typically be employed in the range of 0.05 and 30% by weight, preferably 0.1 to 20% by weight, particularly preferably 1 to 10% by weight, based on the weight of the membrane.

The cross-linking monomers can be introduced onto and into the membrane after the hydrolysis. This can be performed by means of measures known per se (e.g., spraying, immersing) which are known from the prior art.

According to a particular aspect of the present invention, the monomers comprising phosphonic acid and/or sulphonic acid groups or the cross-linking monomers can be polymerised, wherein the polymerisation is preferably a free-radical polymerisation. The formation of radicals can take place thermally, photochemically, chemically and/or electrochemically.

For example, a starter solution containing at least one substance capable of forming radicals can be added to the hydrolysis fluid. Furthermore, the starter solution can be applied to the membrane after the hydrolysis. This can be performed by means of measures known per se (e.g., spraying, immersing) which are known from the prior art.

Suitable radical formers are, amongst others, azo compounds, peroxy compounds, persulphate compounds or azoamidines. Non-limiting examples are dibenzoyl peroxide, dicumene peroxide, cumene hydroperoxide, diisopropyl peroxydicarbonate, bis(4-t-butylcyclohexyl)peroxydicarbonate, dipotassium persulphate, ammonium peroxydisulphate, 2,2′-azobis(2-methylpropionitrile) (AIBN), 2,2′-azobis(isobutyric acid amidine)hydrochloride, benzopinacol, dibenzyl derivatives, methyl ethylene ketone peroxide, 1,1-azobiscyclohexanecarbonitrile, methyl ethyl ketone peroxide, acetyl acetone peroxide, dilauryl peroxide, didecanoyl peroxide, tert-butylper-2-ethyl hexanoate, ketone peroxide, methyl isobutyl ketone peroxide, cyclohexanone peroxide, dibenzoyl peroxide, tert-butylperoxybenzoate, tert-butylperoxyisopropylcarbonate, 2,5-bis(2-ethylhexanoylperoxy)-2,5-dimethylhexane, tert-butylperoxy-2-ethylhexanoate, tert.-butylperoxy-3,5,5-trimethylhexanoate, tert-butylperoxyisobutyrate, tert-butylperoxyacetate, dicumene peroxide, 1,1-bis(tert-butylperoxy)cyclohexane, 1,1-bis(tert-butylperoxy)-3,3,5-trimethylcyclohexane, cumyl hydroperoxide, tert-butylhydroperoxide, bis(4-tert-butylcyclohexyl) peroxydicarbonate, and the radical formers available from DuPont under the name ®Vazo, for example ®Vazo V50 and ®Vazo WS.

Furthermore, it is also possible to employ radical formers which form radicals with irradiation Preferred compounds include, amongst others, α.α-diethoxyacetophenone (DEAP, Upjon Corp), n-butyl benzoin ether (®Trigonal-14, AKZO) and 2,2-dimethoxy-2-phenylacetophenone (®Igacure 651) and 1-benzoyl cyclohexanol (®Igacure 184), bis-(2,4,6-trimethylbenzoyl)phenylphosphine oxide (®Irgacure 819) and 1-[4-(2-hydroxyethoxy)phenyl]-2-hydroxy-2-phenylpropan-1-one (®Irgacure 2959) each of which is commercially available from the company Ciba Geigy Corp.

Typically, between 0.0001 and 5% by weight, in particular 0.01 to 3% by weight (based on the weight of the monomers that can be processed by free-radical polymerisation; monomers comprising phosphonic acid groups and/or sulphonic acid groups or the cross-linking monomers, respectively) of radical formers are added. The amount of radical former can be varied according to the degree of polymerisation desired.

The polymerisation can also take place by action of IR or NIR (IR=infrared, i.e. light having a wavelength of more than 700 nm; NIR=near-IR, i.e. light having a wavelength in the range of about 700 to 2000 nm and an energy in the range of about 0.6 to 1.75 eV), respectively.

The polymerisation can also take place by action of UV light having a wavelength of less than 400 nm. This polymerisation method is known per se and described, for example, in Hans Joerg Elias, Makromolekulare Chemie, 5th edition, volume 1, pp. 492-511; D. R. Arnold, N.C. Baird, J. R. Bolton, J. C. D. Brand, P. W. M Jacobs, P. de Mayo, W. R. Ware, Photochemistry—An Introduction, Academic Press, New York and M. K. Mishra, Radical Photopolymerization of Vinyl Monomers, J. Macromol. Sci.-Revs. Macromol. Chem. Phys. C22 (1982-1983) 409.

The polymerisation may also take place by exposure to β rays, γ rays and/or electron rays. According to a particular embodiment of the present invention, a membrane is irradiated with a radiation dose in the range of 1 to 300 kGy, preferably 3 to 200 kGy and very particularly preferably 20 to 100 kGy.

The polymerisation of the monomers comprising phosphonic acid groups and/or sulphonic acid groups or the cross-linking monomers, respectively, preferably takes place at temperatures of more than room temperature (20° C.) and less than 200° C., in particular at temperatures between 40° C. and 150° C., particularly preferably between 50° C. and 120° C. The polymerisation is preferably performed at normal pressure, but can also be carried out with action of pressure. The polymerisation leads to a solidification of the flat structure, wherein this solidification can be observed via measuring the microhardness. Preferably, the increase in hardness caused by the polymerisation is at least 20%, based on the hardness of a correspondingly hydrolysed membrane without polymerisation of the monomers.

According to a particular aspect of the present invention, the molar ratio of the molar sum of phosphoric acid, polyphosphoric acid and the hydrolysis products of polyphosphoric acid to the number of moles of the phosphonic acid groups and/or sulphonic acid groups in the polymers obtainable by polymerisation of monomers comprising phosphonic acid groups and/or monomers comprising sulphonic acid groups is preferably greater than or equal to 1:2, in particular greater than or equal to 1:1 and particularly preferably greater than or equal to 2:1.

Preferably, the molar ratio of the molar sum of phosphoric acid, polyphosphoric acid and the hydrolysis products of polyphosphoric acid to the number of moles of the phosphonic acid groups and/or sulphonic acid groups in the polymers obtainable by polymerisation of monomers comprising phosphonic acid groups and/or monomers comprising sulphonic acid groups lies in the range of 1000:1 to 3:1, in particular 100:1 to 5:1 and particularly preferably 50:1 to 10:1.

The molar ratio can be determined by means of customary methods. To this end, especially spectroscopic methods, for example, NMR spectroscopy, can be employed. In this connection, it has to be considered that the phosphonic acid groups are present in the formal oxidation stage 3 and the phosphorus in phosphoric acid, polyphosphoric acid or hydrolysis products thereof, respectively, in oxidation stage 5.

Depending on the degree of polymerisation desired, the flat structure which is obtained after polymerisation is a self-supporting membrane. Preferably, the degree of polymerisation is at least 2, in particular at least 5, particularly preferably at least 30, repeating units, in particular at least 50 repeating units, very particularly preferably at least 100 repeating units. This degree of polymerisation is determined via the number-average molecular weight Mₙ, which can be determined by means of GPC methods. Due to the problems of isolating the polymers comprising phosphonic acid groups contained in the membrane without degradation, this value is determined by means of a sample which is obtained by polymerisation of monomers comprising phosphonic acid groups without addition of polymer. In this connection, the weight proportion of monomers comprising phosphonic acid groups and of radical starters in comparison to the ratios of the production of the membrane is kept constant. The conversion achieved in a comparative polymerisation is preferably greater than or equal to 20%, in particular greater than or equal to 40% and particularly preferably greater than or equal to 75%, based on the monomers containing phosphonic acid groups which are used.

The hydrolysis fluid comprises water, wherein the concentration of the water generally is not particularly critical. According to a particular aspect of the present invention, the hydrolysis fluid comprises 5 to 80% by weight, preferably 8 to 70% by weight and particularly preferably 10 to 50% by weight, of water. The amount of water which is formally included in the oxo acids is not taken into account in the water content of the hydrolysis fluid.

Of the above-mentioned acids, phosphoric acid and/or sulphuric acid are particularly preferred, wherein these acids comprise in particular 5 to 70% by weight, preferably 10 to 60% by weight and particularly preferably 15 to 50% by weight, of water.

The partial hydrolysis of the polyphosphoric acid in step D) leads to a solidification of the membrane and a reduction in the layer thickness and the formation of a membrane having a thickness between 15 and 3000 μm, preferably between 20 and 2000 μm, in particular between 20 and 1500 μm, which is self-supporting. The intramolecular and intermolecular structures (interpenetrating networks IPN) that, in accordance with step B) that are present in the polyphosphoric acid layer lead to an ordered membrane formation in step C), which is responsible for the special properties of the membrane formed.

The upper temperature limit for the treatment in accordance with step D) is typically 150° C. With extremely short action of moisture, for example from overheated steam, this steam can also be hotter than 150° C. The duration of the treatment is substantial for the upper limit of the temperature.

The partial hydrolysis (step D) can also take place in climatic chambers where the hydrolysis can be specifically controlled with defined moisture action. In this connection, the moisture can be specifically set via the temperature or saturation of the surrounding area in contact with it, for example gases such as air, nitrogen, carbon dioxide or other suitable gases, or steam. The duration of the treatment depends on the parameters chosen as aforesaid.

Furthermore, the duration of the treatment depends on the thickness of the membrane.

Typically, the duration of the treatment amounts to a few seconds to minutes, for example with action of overheated steam, or up to whole days, for example in the open air at room temperature and lower relative humidity. Preferably, the duration of the treatment is 10 seconds to 300 hours, in particular 1 minute to 200 hours.

If the partial hydrolysis is performed at room temperature (20° C.) with ambient air having a relative humidity of 40-80%, the duration of the treatment is 1 to 200 hours.

The membrane obtained in accordance with step D) can be formed in such a way that it is self-supporting, i.e. it can be detached from the support without any damage and then directly processed further, if applicable.

The concentration of phosphoric acid and therefore the conductivity of the polymer membrane can be set via the degree of hydrolysis, i.e. the duration, temperature and ambient humidity. The concentration of the phosphoric acid is given as mole of acid per mole of repeating unit of the polymer. Membranes with a particularly high concentration of phosphoric acid can be obtained by the method comprising the steps A) to D). A concentration of 10 to 50 (mol of phosphoric acid related to a repeating unit of formula (I) for example polybenzimidazole), particularly between 12 and 40 is preferred. Only with very much difficulty or not at all is it possible to obtain such high degrees of doping (concentrations) by doping polyazoles with commercially available orthophosphoric acid.

According to a modification of the method described wherein doped polyazole films are produced by using polyphosphoric acid, the production of these films can be carried out by a method comprising the following steps:
1) reacting one or more aromatic tetraamino compounds with one or more aromatic carboxylic acids or their esters which contain at least two acid groups per carboxylic acid monomer, or one or more aromatic and/or heteroaromatic diaminocarboxylic acids in the melt at temperatures of up to 350° C., preferably up to 300° C.,
2) dissolving the solid prepolymer obtained in accordance with step 1) in polyphosphoric acid,
3) heating the solution obtainable in accordance with step 2) under inert gas to temperatures of up to 300° C., preferably up to 280° C., with formation of the dissolved polyazole polymer,
4) forming a membrane using the solution of the polyazole polymer in accordance with step 3) on a support and
5) treatment of the membrane formed in step 4) until it is self-supporting.

The steps of the method described under items 1) to 5) have been explained in detail for the steps A) to D), where reference is made thereto, particularly with regard to the preferred embodiments.

A membrane, particularly a membrane based on polyazoles, can further be cross-linked at the surface by action of heat in the presence of atmospheric oxygen. This hardening of the membrane surface further improves the properties of the membrane. To this end, the membrane can be heated to a temperature of at least 150° C., preferably at least 200° C. and particularly preferably at least 250° C. In this process step, the oxygen concentration usually is in the range of 5 to 50% by volume, preferably 10 to 40% by volume; however, this should not constitute a limitation.

The cross-linking can also take place by action of IR or NIR (IR=infrared, i.e. light having a wavelength of more than 700 nm; NIR=near-IR, i.e. light having a wavelength in the range of about 700 to 2000 nm and an energy in the range of about 0.6 to 1.75 eV), respectively. Another method is β-ray irradiation. In this connection, the irradiation dose is from 5 and 200 kGy.

Depending on the desired degree of crosslinking, the duration of the crosslinking reaction may lie within a wide range. Generally, this reaction time is in the range of 1 second to 10 hours, preferably 1 minute to 1 hour; however, this should not constitute a limitation.

Particularly preferred polymer membranes show a high performance. The reason for this is in particular improved proton conductivity. This is at least 1 mS/cm, preferably at least 2 mS/cm, in particular at least 5 mS/cm at temperatures of 120° C. Here, these values are achieved without moistening.

The specific conductivity is measured by means of impedance spectroscopy in a 4-pole arrangement in potentiostatic mode and using platinum electrodes (wire, 0.25 mm diameter). The distance between the current-collecting electrodes is 2 cm. The spectrum obtained is evaluated using a simple model comprised of a parallel arrangement of an ohmic resistance and a capacitor. The cross-section of the specimen of the membrane doped with phosphoric acid is measured immediately before mounting the specimen. To measure the temperature dependency, the measurement cell is brought to the desired temperature in an oven and regulated using a Pt-100 thermocouple arranged in the immediate vicinity of the specimen. Once the temperature is reached, the specimen is held at this temperature for 10 minutes prior to the start of measurement.

### Gas Diffusion Layer

The membrane electrode unit according to the invention has two gas diffusion layers which are separated by the polymer electrolyte membrane. Flat, electrically conductive and acid-resistant structures are commonly used for this. These include, for example, graphite-fibre paper, carbon-fibre paper, graphite fabric and/or paper which was rendered conductive by addition of carbon black. Through these layers, a fine distribution of the flows of gas and/or liquid is achieved.

Generally, this layer has a thickness in the range of 80 μm to 2000 μm, in particular 100 μm to 1000 μm and particularly preferably 150 μm to 500 μm.

According to a particular embodiment, at least one of the gas diffusion layers can be comprised of a compressible material. Within the scope of the present invention, a compressible material is characterized by the characteristic that the gas diffusion layer can be compressed by pressure to half, in particular a third of its original thickness without losing its integrity.

This characteristic is generally exhibited by a gas diffusion layer made of graphite fabric and/or paper which was rendered conductive by addition of carbon black.

### Catalyst Layer

The catalyst layer(s) contain(s) catalytically active substances. These include, amongst others, precious metals of the platinum group, i.e. Pt, Pd, Ir, Rh, Os, Ru, or also the precious metals Au and Ag. Furthermore, alloys of the above-mentioned metals may also be used. Additionally, at least one catalyst layer can contain alloys of the elements of the platinum group with non-precious metals, such as for example Fe, Co, Ni, Cr, Mn, Zr, Ti, Ga, V, etc. Furthermore, the oxides of the above-mentioned precious metals and/or non-precious metals can also be employed.

The catalytically active particles comprising the above-mentioned substances may be employed as metal powder, so-called black precious metal, in particular platinum and/or platinum alloys. Such particles generally have a size in the range of 5 nm to 200 nm, preferably in the range of 7 nm to 100 nm.

Furthermore, the metals can also be employed on a support material. Preferably, this support comprises carbon which particularly may be used in the form of carbon black, graphite or graphitised carbon black. Furthermore, electrically conductive metal oxides, such as for example, SnOₓ, TiOₓ, or phosphates, such as e.g. FePOₓ, NbPOₓ, Zr_{y}(POₓ)_{z}, can be used as support material. In this connection, the indices x, y and z designate the oxygen or metal content of the individual compounds which can lie within a known range as the transition metals can be in different oxidation stages.

The content of these metal particles on a support, based on the total weight of the bond of metal and support, is generally in the range of 1 to 80% by weight, preferably 5 to 60% by weight and particularly preferably 10 to 50% by weight; however, this should not constitute a limitation. The particle size of the support, in particular the size of the carbon particles, is preferably in the range of 20 to 1000 nm, in particular 30 to 100 nm. The size of the metal particles present thereon is preferably in the range of 1 to 20 nm, in particular 1 to 10 nm and particularly preferably 2 to 6 nm.

The sizes of the different particles represent mean values and can be determined via transmission electron microscopy or X-ray powder diffractometry.

The catalytically active particles set forth above can generally be obtained commercially.

Furthermore, the catalytically active layer may contain customary additives. These include, amongst others, fluoropolymers, such as e.g. polytetrafluoroethylene (PTFE), proton-conducting ionomers and surface-active substances.

According to a particular embodiment of the present invention, the weight ratio of fluoropolymer to catalyst material comprising at least one precious metal and optionally one or more support materials is greater than 0.1, this ratio preferably lying within the range of 0.2 to 0.6.

According to a particular embodiment of the present invention, the catalyst layer has a thickness in the range of 1 to 1000 μm, in particular from 5 to 500, preferably from 10 to 300 μm. This value represents a mean value which can be determined by averaging the measurements of the layer thickness from photographs that can be obtained with a scanning electron microscope (SEM).

According to a particular embodiment of the present invention, the content of precious metals of the catalyst layer is 0.1 to 10.0 mg/cm², preferably 0.3 to 6.0 mg/cm² and particularly preferably 0.3 to 3.0 mg/cm². These values can be determined by elemental analysis of a flat specimen.

For further information on membrane electrode units, reference is made to the technical literature, in particular the patent applications WO 01/18894 A2, DE 195 09 748, DE 195 09 749, WO 00/26982, WO 92/15121 and DE 197 57 492. The disclosure contained in the above-mentioned citations with respect to the structure and production of membrane electrode units as well as the electrodes, gas diffusion layers and catalysts to be chosen is also part of the description.

The electrochemically active surface area of the catalyst layer defines the surface which is in contact with the polymer electrolyte membrane and at which the redox reactions set forth above can take place. The present invention allows for the formation of particularly large electrochemically active surface areas. According to a particular aspect of the present invention, the size of this electrochemically active surface area is at least 2 cm², in particular at least 5 cm² and preferably at least 10 cm²; however, this should not constitute a limitation. The term electrode means that the material exhibits electron conductivity, the electrode defining the electrochemically active area.

### Spacer

In general, the membrane has a relatively low pressure stability. To avoid damage to the membrane during operation of the fuel cell, precautions have to be taken, which prevent a compression. For example, the separator plates can be formed accordingly.

Preferably, a spacer is employed. In particular, the spacer can form a frame in which the inner, recessed surface area of the frame preferably corresponds with the surface area of the membrane electrode unit.

Preferably, the spacer is made of pressure-resistant material. The thickness of the spacer preferably decreases over a period of 5 hours by not more than 5% at a temperature of 80° C. and a pressure of 5 N/mm², wherein this decrease in thickness is determined after a first compression step which takes place over a period of 1 minute at a pressure of 5 N/mm².

The thickness of the spacer is preferably 50 to 100%, in particular 65% to 95% and particularly preferably 75% to 85%, based on the thickness of all the components of the inner area of the membrane electrode unit.

This characteristic of the spacer, in particular the frame is generally achieved through the use of polymers having a high pressure stability. In many cases, at least one spacer has a multilayer structure.

Preferably, the thickness of the spacer decreases over a period of 5 hours, particularly preferably 10 hours, by not more than 2%, preferably not more than 1%, at a temperature of 120° C., particularly preferably 160° C., and a pressure of 10 N/mm², in particular 15 N/mm² and particularly preferably 20 N/mm².

The polymer electrolyte membrane has an inner area which is contacted with a catalyst layer, and an outer area which is not provided on the surface of a gas diffusion layer. In this connection, provided means that the inner area has no area overlapping with a gas diffusion layer if an inspection perpendicular to the surface of a gas diffusion layer or of the outer area of the polymer electrolyte membrane is carried out, such that, only after contacting the polymer electrolyte membrane with the gas diffusion layer, an allocation can be made.

The thickness of the outer area of the membrane is greater than the thickness of the inner area. Preferably, the outer area of the membrane is at least 5 μm, particularly preferably at least 20 μm and very particularly preferably at least 100 μm thicker than the inner area of the membrane.

According to a preferred aspect of the present invention, the four edges of the two gas diffusion layers can be in contact with the polymer electrolyte membrane. Accordingly, the use of another gasket or layer is not required. The edges of the gas diffusion layer are formed by the thickness of the gas diffusion layer as well as the length or width. In this connection, the thickness is the smallest linear expansion of the body.

The outer area of the polymer electrolyte membrane can have a monolayer structure. In this case, the outer area of the polymer electrolyte membrane generally consists of the same material as the inner area of the polymer electrolyte membrane.

Furthermore, the outer area of the polymer electrolyte membrane can comprise in particular at least one more layer, preferably at least two more layers. In this case, the outer area of the polymer electrolyte membrane has at least two or at least three components.

According to a particular aspect of the present invention, the spacer comprises at least one, preferably at least two polymer layers having a thickness greater than or equal to 10 μm, each of the polymers of these layers having a tension of at least 6 N/mm² preferably at least 7 N/mm², measured at 80° C., preferably 160° C., and an elongation of 100%. Measurement of these values is carried out in accordance with DIN EN ISO 527-1.

The polymer layers can extend beyond the spacer. In this connection, these polymer layers can also be in contact with the outer area of the membrane. Accordingly, the further layers of the outer area of the membrane described above and the further layers of the spacer can form a common layer.

According to a particular aspect of the present invention, a layer can be applied by thermoplastic processes, for example injection moulding or extrusion. Accordingly, a layer is preferably made of a meltable polymer.

Within the scope of the present invention, preferably used polymers preferably exhibit a long-term service temperature of at least 190° C., preferably at least 220° C. and particularly preferably at least 250° C., measured in accordance with MIL-P-46112B, paragraph 4.4.5.

Preferred meltable polymers include in particular fluoropolymers, such as for example poly(tetrafluoroethylene-co-hexafluoropropylene) FEP, polyvinylidenefluoride PVDF, perfluoroalkoxy polymer PFA, poly(tetrafluoroethylen-co-perfluoro(methylvinylether)) MFA. These polymers are in many cases commercially available, for example under the trade names Hostafon®, Hyflon®, Teflon®, Dyneon® and Nowoflon®.

One or both layers can be made of, amongst others, polyphenylenes, phenol resins, phenoxy resins, polysulphide ether, polyphenylenesulphide, polyethersulphones, polyimines, polyetherimines, polyazoles, polybenzimidazoles, polybenzoxazoles, polybenzothiazoles, polybenzoxadiazoles, polybenzotriazoles, polyphosphazenes, polyether ketones, polyketones, polyether ether ketones, polyether ketone ketones, polyphenylene amides, polyphenylene oxides and mixtures of two or more of these polymers.

According to a preferred aspect of the present invention, the spacer has a polyimide layer. Polyimids are known by those in the field. These polymers have imide groups as essential structural units of the backbone and are described, e.g. in Ullmann's Encyclopedia of Industrial Chemistry 5^{th} Ed. on CD-ROM, 1998, Keyword Polyimides. The polyimides also include polymers also containing, besides imide groups, amide (polyamideimides), ester (polyesterimides) and ether groups (polyetherimides) as components of the backbone.

Preferred polyimids include recurring units of the formula (VI),

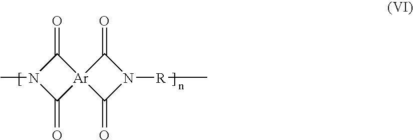

wherein the radical Ar has the meaning set forth above and the radical R represents an alkyl group or a bicovalent aromatic or heteroaromatic group with 1 to 40 carbon atoms. Preferably, the radical R represents a bicovalent aromatic or heteroaromatic group derived from benzene, naphthalene, biphenyl, diphenyl ether, diphenyl ketone, diphenylmethane, diphenyldimethylmethane, bisphenone, diphenylsulphone, quinoline, pyridine, bipyridine, anthracene, thiadiazole and phenanthrene, which optionally also can be substituted. The index n suggests the recurring units represent parts of polymers.

Such polymers are commercially available under the trade names ®Kapton, ®Vespel, ®Toray and ®Pyralin from DuPont as well as ®Ultem from GE Plastics and ®Upilex from Ube Industries.

The thickness of the polyimide layer is preferably in the range of 50 to 1000 μm in particular 10 μm to 500 μm and particularly preferably 25 μm to 100 μm.

The different layers can be connected with each other by use of suitable polymers. These include in particular fluoropolymers. Suitable fluoropolymers are known to those in the field. These include, amongst others, polytetrafluoroethylene (PTFE) and poly(tetrafluoroethylen-co-hexafluoropropylene) (FEP). The layer made of fluoropolymers present on the layers described above in general has a thickness of at least 0.5 μm, in particular at least 2.5 μm. This layer can be provided between the polymer electrolyte membrane and the polyimide layer. Furthermore, the layer can also be applied to the side facing away from the polymer electrolyte membrane. Additionally, both surfaces of the polyimide layer can be provided with a layer made of fluoropolymers. Surprisingly, it is possible to improve the long-term stability of the MEUs through this.

Polyimide films provided with fluoropolymers which can be used according to the invention are commercially available under the trade name ©Kapton FN from DuPont.

At least one frame is usually in contact with electrically conductive separator plates, which are typically provided with flow field channels on the sides facing the gas diffusion layers to allow for the distribution of reactant fluids. The separator plates are usually manufactured of graphite or conductive, thermally stable plastic.

The thickness of all components of the outer area of the polymer electrolyte membrane or the thickness of the spacer, respectively, is greater than the thickness of the inner area of the polymer electrolyte membrane. The thickness of the outer area relates to the sum of the thicknesses of all components of the outer area. The components of the outer area result from the vector parallel to the surface area of the outer area of the polymer electrolyte membrane, wherein the layers that this vector intersects are to be added to the components of the outer area.

The outer area preferably has a thickness in the range of 80 μm to 4000 μm, in particular in the range of 120 μm to 2000 μm and particularly preferably in the range of 150 μm to 800 μm.

The thickness of all components of the outer area can be, for example, 50% to 100%, preferably 65% to 95% and particularly preferably 75% to 85%, based on the sum of the thickness of all components of the inner area. In this connection, the thickness of the components of the outer area relates to the thickness these components have after a first compression step which is performed at a pressure of 5 N/mm² preferably 10 N/mm² over a period of 1 minute. The thickness of the components of the inner area relates to the thicknesses of the layers employed, without a compression step being necessary in this connection.

The thickness of all components of the inner area results in general from the sum of the thicknesses of the membrane, the catalyst layers and the gas diffusion layers of the anode and cathode.

The thickness of the layers is determined with a digital thickness tester from the company Mitutoyo. The initial pressure of the two circular flat contact surfaces during measurement is 1 PSI, the diameter of the contact surface is 1 cm.

The catalyst layer is in general not self-supporting but is usually applied to the gas diffusion layer and/or the membrane. In this connection, part of the catalyst layer can, for example, diffuse into the gas diffusion layer and/or the membrane, resulting in the formation of transition layers. This can also lead to the catalyst layer being understood as part of the gas diffusion layer. The thickness of the catalyst layer results from measuring the thickness of the layer onto which the catalyst layer was applied, for example the gas diffusion layer or the membrane, the measurement providing the sum of the catalyst layer and the corresponding layer, for example the sum of the gas diffusion layer and the catalyst layer.

The measurement of the pressure- and temperature-dependent deformation parallel to the surface vector of the components of the outer area, in particular the spacer, is performed with a hydraulic press with heatable press plates. The measurement of the thickness and the change in thickness under compressive stress of the inner area of the membrane likewise is performed with a hydraulic press with heatable press plates. In this connection, the material can evade the compressive stress via the edges.

In this connection, the hydraulic press exhibits the following technical data:

The press has a force range of 50-50000 N with a maximum compression area of 220×220 mm². The resolution of the pressure sensor is ±1 N.
An inductive distance sensor with a measuring range of 10 mm is attached to the press plates. The resolution of the distance sensor is ±1 μm.
The press plates can be operated in a temperature range of RT-200° C.
The press is operated in a force-controlled mode by means of a PC with corresponding software.
The data of the force and distance sensor are recorded and depicted in real time at a data rate of up to 100 measured data/second.

### Testing Method:

The material to be tested is cut to a surface area of 55×55 mm² and placed between the press plates preheated to 80° C., 120° C. and 160° C., respectively.

The press plates are closed and an initial force of 120 N is applied such that the control circuit of the press is closed. At this point, the distance sensor is set to 0. Subsequently, a pressure ramp previously programmed is executed. To this end, the pressure is increased at a rate of 2 N/mm²s to a predefined value, for example 5, 10, 15 or 20 N/mm², and this value is maintained for at least 5 hours. After completing the total holding time, the pressure is decreased to 0 N/mm² with a ramp of 2 N/mm²s and the press is opened.

The relative and/or absolute change in thickness can be read from a deformation curve recorded during the pressure test or can be measured following the pressure test through a measurement with a standard thickness tester.

At least one component of the outer area of the polymer electrolyte membrane is usually in contact with electrically conductive separator plates which are typically provided with flow field channels on the sides facing the gas diffusion layers to allow for the distribution of reactant fluids. The separator plates are usually manufactured of graphite or conductive, thermally stable plastic.

Interacting with the separator plates, the components of the outer area seal the gas spaces against the outside. Furthermore, interacting with the inner area of the polymer electrolyte membrane, the components of the outer area generally also seal the gas spaces between anode and cathode. Surprisingly, it was therefore found that an improved sealing concept can result in a fuel cell with a prolonged service life.

The following figures describe different embodiments of the present invention, these figures intended to deepen the understanding of the present invention; however, this should not constitute a limitation.

The figures show:

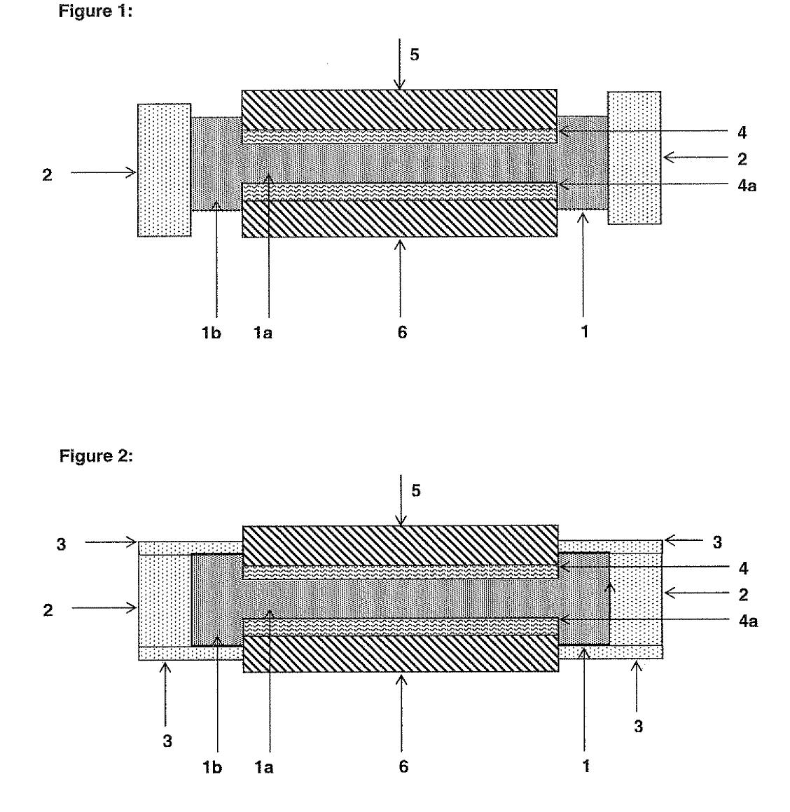

FIG. 1 a diagrammatical cross-section of a membrane electrode unit according to the invention, the catalyst layer being applied to the gas diffusion layer,

FIG. 2 a diagrammatical cross-section of a second membrane electrode unit according to the invention, the catalyst layer being applied to the gas diffusion layer,

FIG. 1 shows a cross-sectional side view of a membrane electrode unit according to the invention. It is a diagram wherein the depiction describes the state before compression and the spaces between the layers are intended to improve the understanding. Here, the polymer electrolyte membrane 1 has an inner area 1a and an outer area 1b. The inner area of the polymer electrolyte membrane is in contact with the catalyst layers 4 and 4a. A gas diffusion layer 5, 6 having a catalyst layer 4 or 4a, respectively, is provided on each of the two sides of the surface of the inner area of the polymer electrolyte membrane 1. Through this, a gas diffusion layer 5 provided with a catalyst layer 4 forms the anode or the cathode, respectively, whereas the second gas diffusion layer 6 provided with a catalyst layer 4a forms the cathode or the anode, respectively. The membrane electrode unit is enclosed by a spacer 2. The thickness of the outer area 1b and the spacer 2, respectively, is in the range of 50 to 100%, preferably 65 to 95% and particularly preferably 75 to 85%, of the thickness of the layers 1a+4+4a+5+6.

FIG. 2 shows a cross-sectional side view of a membrane electrode unit according to the invention. It is a diagram wherein the depiction describes the state before compression and the spaces between the layers are intended to improve the understanding. Here, the polymer electrolyte membrane 1 has an inner area 1a and an outer area 1b. The inner area of the polymer electrolyte membrane is in contact with the catalyst layers 4 and 4a. A gas diffusion layer 5, 6 having a catalyst layer 4 or 4a, respectively, is provided on each of the two sides of the surface of the inner area of the polymer electrolyte membrane 1. Through this, a gas diffusion layer 5 provided with a catalyst layer 4 forms the anode or the cathode, respectively, whereas the second gas diffusion layer 6 provided with a catalyst layer 4a forms the cathode or the anode, respectively. The membrane electrode unit is enclosed by a spacer 2. The spacer and the outer area of the membrane are connected with each other via another layer 3. The thickness of the outer area 1b and the further layer 3 and the spacer 2 and the further layer 3, respectively, is in the range of 50 to 100%, preferably 65 to 95% and particularly preferably 75 to 85%, of the thickness of the layers 1a+4+4a+5+6.

The production of a membrane electrode unit according to the invention is apparent to the person skilled in the art. Generally, the different components of the membrane electrode unit are superposed and connected with each other by pressure and temperature. In general, lamination is carried out at a temperature in the range of 10 to 300° C., in particular 20° C. to 200° C. and with a pressure in the range of 1 to 1000 bar, in particular 3 to 300 bar. In this connection, a precaution is usually taken, which prevents damage to the membrane in the inner area. For this, a shim, i.e. a spacer can be employed, for example.

According to a particular aspect of the present invention, the production of MEUs can preferably be performed continuously in this connection. Here, the simple construction of the system favours a production process in particularly few steps as the electrodes matching in size, i.e. the gas diffusion layers provided with catalyst layers can be easily pressed into the membrane on both sides. For example, the material provided for the membrane can be drawn off from a reel. Electrodes are applied to both sides of this section of the material und it is pressed, it being possible to prevent damage to the membrane through distance pieces, for example. After pressing, the section can be cut off and processed or packaged. The steps required for this can in particular be performed simply by machine, which can be performed continuously or fully automated. In comparison to conventional sealing systems, the spacer allows for a simple production of the fuel cells as the pressed MEUs simply have to be introduced into a corresponding frame made of spacer material. The combination thus obtained can subsequently be processed to obtain a fuel cell. The sealing systems usually employed with high expense which can only be obtained in many production steps can therefore be dispensed with.

After cooling, the finished membrane electrode unit (MEU) is operational and can be used in a fuel cell.

Particularly surprising, it was found that membrane electrode units according to the invention can be stored or shipped without any problems, due to their dimensional stability at varying ambient temperatures and humidity. Even after prolonged storage or after shipping to locations with markedly different climatic conditions, the dimensions of the MEU are right to be fitted into fuel cell stacks without difficulty. In this case, the MEU need not be conditioned for an external assembly on site which simplifies the production of the fuel cell and saves time and cost.

One benefit of preferred MEUs is that they allow for the operation of the fuel cell at temperatures above 120° C. This applies to gaseous and liquid fuels, such as e.g. hydrogen-containing gases that are produced e.g. in an upstream reforming step from hydrocarbons. In this connection, oxygen or air can, e.g., be used as oxidant.

Another benefit of preferred MEUs is that, during operation at more than 120° C., they have a high tolerance to carbon monoxide, even with pure platinum catalysts, i.e. without any further alloy components. At temperatures of 160° C., e.g. more than 1% CO can be contained in the fuel without this leading to a markedly reduction in performance of the fuel cell.

Preferred MEUs can be operated in fuel cells without the need to moisten the fuels and the oxidants despite the high operating temperatures possible. The fuel cell nevertheless operates in a stabile manner and the membrane does not lose its conductivity. This simplifies the entire fuel cell system and results in additional cost savings as the guidance of the water circulation is simplified. Furthermore, the behaviour of the fuel cell system at temperatures of less than 0° C. is also improved through this.

Preferred MEUs surprisingly make it possible to cool the fuel cell to room temperature and lower without difficulty and to subsequently put it back into operation without a loss in performance.

Furthermore, the concept of the present invention allows for a particularly good utilisation of the catalysts, in particular the platinum metals employed. In this connection, it has to be considered that in conventional concepts a part of the gas diffusion layers coated with platinum is covered with gasket materials and therefore has no catalytic effect.

Furthermore, costs resulting from the use of gasket materials can be reduced.

Furthermore, the preferred MEUs of the present invention exhibit a very high long-term stability. It was found that a fuel cell according to the invention can be continuously operated over long periods of time, e.g. more than 5000 hours, at temperatures of more than 120° C. with dry reaction gases without it being possible to detect an appreciable degradation in performance. The power densities obtainable in this connection are very high, even after such a long period of time.

In this connection, the fuel cells according to the invention exhibit, even after a long period of time, for example more than 5000 hours, a high off-load voltage which is preferably at least 900 mV, particularly preferably at least 920 mV after this period of time. To measure the open circuit voltage, a fuel cell with a hydrogen flow on the anode and an air flow on the cathode is operated currentless. The measurement is carried out by switching the fuel cell from a current of 0.2 A/cm² to the currentless state and then recording the open circuit voltage for 2 minutes from this point onwards. The value after 5 minutes is the respective open circuit potential. The measured values of the H₂ cross over apply to a temperature of 160° C. Furthermore, the fuel cell preferably exhibits a low gas cross over after this period of time. To measure the cross over, the anode side of the fuel cell is operated with hydrogen (5 l/h), the cathode with nitrogen (5 l/h). The anode serves as the reference and counter electrode, the cathode as the working electrode. The cathode is set to a potential of 0.5 V and the hydrogen diffusing through the membrane and whose mass transfer is limited at the cathode oxidizes. The resulting current is a variable of the hydrogen permeation rate. The current is <3 mA/cm², preferably <2 mA/cm², particularly preferably <1 mA/cm² in a cell of 50 cm². The measured values of the H₂ cross over apply to a temperature of 160° C.

Furthermore, the MEUs according to the invention can be produced inexpensive and in an easy way.

For further information on membrane electrode units, reference is made to the technical literature, in particular the patents U.S. Pat. No. 4,191,618, U.S. Pat. No. 4,212,714 and U.S. Pat. No. 4,333,805. The disclosure contained in the above-mentioned citations [U.S. Pat. No. 4,191,618, U.S. Pat. No. 4,212,714 und U.S. Pat. No. 4,333,805] with respect to the structure and production of membrane electrode units as well as the electrodes, gas diffusion layers and catalysts to be chosen is also part of the description.

The present invention will be explained in more detail below on the basis of an example and a comparative example, without this being intended to represent any limitation.

### Preparation of a PBI Solution

350 g of polyphosphoric acid (PPA) is added to a mixture of 3.1 g of terephthalic acid and 4.0 g of 3,3′,4,4′-tetraaminobiphenyl in a three-necked flask added, which is equipped with a mechanical stirrer, N₂ inlet and outlet. The mixture was initially heated to 150° C. for 1 h, then to 170° C. for 10 h, subsequently to 195° C. for 7 h and finally to 220° C. for 4 h, with stirring.

A small portion of the solution was precipitated with water. The precipitated resin was filtered, washed three times with H₂O, neutralised with ammonium hydroxide, then washed with H₂O and dried at 100° C. and 0.001 bar for 24 h. The inherent viscosity ηᵢₙₕ of a 0.2 g/dl polymer solution in 100 ml of 96% H₂SO₄ was measured. ηᵢₙₕ=6.4 dl/g at 30° C.

### EXAMPLE 1

A membrane was produced from the PBI solution set forth above. To this end, the obtained mixture was applied to a glass plate with a preheated doctor blade in a thickness of 1150 μm. The membrane was cooled to room temperature and then hydrolysed for 24 h in a 2 l bath of 50% H₃PO₄ at RT. The thickness of the hydrolysed membrane was 1000 μm.

The membrane thus obtained was used to produce a membrane electrode unit. The surface area of the membrane was 100 mm*100 mm. The membrane was placed between an anode and a cathode and pressed at 160° C. to a total thickness of 980 μm.

A diffusion layer made of graphite fabric and coated with catalyst was used as the anode. The anode catalyst is Pt on a carbon support. The electrode loading is 1 mg_{Pt}/cm².

A diffusion layer made of graphite fabric and coated with catalyst was used as the cathode. The cathode catalyst is Pt on a carbon support. The electrode loading is 1 mg_{Pt}/cm².

A frame made of perfluoroalkoxy polymer (PFA) that surrounds the membrane electrode unit is used as the spacer.

The active surface area of the MEU is 50 cm² and the total surface area 100 cm². The thickness of the membrane in the inner area was on average 190 μm, the thickness in the outer area on average 363 μm. These values were obtained by evaluating photographs that were obtained by scanning electron microscopy (SEM).

The performances of the membrane were measured in accordance with the methods set forth above. The obtained results are set forth in table 1.

### COMPARATIVE EXAMPLE 1

A membrane was produced from the PBI solution set forth above. For this, the obtained mixture was processed to a membrane having a thickness of 300 μm and a surface area of 72 mm×72 mm in order to produce a MEU.

A diffusion layer made of graphite fabric and coated with catalyst was used as the anode, wherein the anode is framed by a subgasket made of Kapton film (25 μm). The anode catalyst is Pt on a carbon support. The electrode loading is 1 mg_{Pt}/cm².

A diffusion layer made of graphite fabric and coated with catalyst was used as the cathode, wherein the cathode is framed by a subgasket made of Kapton film (25 μm). The cathode catalyst is Pt on a carbon support. The electrode loading is 1 mg_{Pt}/cm². The sealing of the edges was achieved in a conventional manner with a gasket made of PFA.

The membrane was placed between anode and cathode and pressed at 160° C. to a total thickness of 980 μm. The active surface area of the MEU is 50 cm².

The performances of the membrane were measured in accordance with the methods set forth above. The obtained results are set forth in table 1.

TABLE 1

| | Example | Comparative sample |
|---|---|---|
| open circuit voltage [mV] | 930 | 915 |
| [mV] @ 0.2 A/cm² | 645 | 645 |

T: 160° C.; p: 1 barₐ

1-27. (canceled)

28. A membrane electrode unit having two gas diffusion layers, each contacted with a catalyst layer and which are separated by a polymer electrolyte membrane, wherein said polymer electrolyte membrane has an inner area which is contacted with a catalyst layer, and an outer area which is not provided on the surface of a gas diffusion layer, wherein the thickness of the inner area of the membrane decreases over a period of 10 minutes by at least 5% at a pressure of 5 N/mm² and the thickness of the membrane in the outer area is greater than the thickness of the inner area of the membrane.

29. The membrane electrode unit of claim 28, wherein the four edges of the two gas diffusion layers are contacted with the polymer electrolyte membrane.

30. The membrane electrode unit of claim 28, wherein the outer area has a monolayer structure.

31. The membrane electrode unit of claim 28, wherein the outer area of the polymer electrolyte membrane has at least one more layer.

32. The membrane electrode unit of claim 31, wherein the outer area of the polymer electrolyte membrane has at least one polymer layer which is meltable.

33. The membrane electrode unit of claim 32, wherein the polymer layer comprises fluoropolymers.

34. The membrane electrode unit of claim 28, wherein the outer area comprises at least two polymer layers having a thickness greater than or equal to 10 pm, each of the polymers of these layers having a modulus of elasticity of at least 6 N/mm², measured at 160° C. and an elongation of 100%.

35. The membrane electrode unit of claim 28, wherein the inner area of the polymer electrolyte membrane has a thickness in the range of 15 to 1000 μm.

36. The membrane electrode unit of claim 28, wherein the outer area has a thickness in the range of 120 to 2000 μm.

37. The membrane electrode unit of claim 28, wherein the ratio of the thickness of the outer area to the thickness of the inner area of the polymer electrolyte membrane is in the range of 1:1 to 200:1.

38. The membrane electrode unit of claim 28, wherein each of the two catalyst layers has an electrochemically active surface area, the size of which is at least 2 cm².

39. The membrane electrode unit of claim 28, wherein the polymer electrolyte membrane comprises polyazoles.

40. The membrane electrode unit of claim 28, wherein the polymer electrolyte membrane is doped with an acid.

41. The membrane electrode unit of claim 40, wherein the polymer electrolyte membrane is doped with phosphoric acid.

42. The membrane electrode unit of claim 41, wherein the concentration of the phosphoric acid is at least 50% by weight.

43. The membrane electrode unit of claim 28, wherein the membrane can be obtained by a process comprising:
A) mixing one or more aromatic tetraamino compounds with one or more aromatic carboxylic acids or their esters, which contain at least two acid groups per carboxylic acid monomer, or mixing one or more aromatic and/or heteroaromatic diaminocarboxylic acids in polyphosphoric acid with formation of a solution and/or dispersion;
B) applying a layer using the mixture of A) to a support or to an electrode;
C) heating the flat structure/layer of step B) under inert gas to temperatures of up to 350° C., with formation of the polyazole polymer;
D) treating the membrane formed in C) until it is self-supporting.

44. The membrane electrode unit of claim 41, wherein the degree of doping is between 3 and 50.

45. The membrane electrode unit of claim 28, wherein at least one of the electrodes is made of a compressible material.

46. The membrane electrode unit of claim 28, wherein the membrane comprises polymers which can be obtained by free-radical polymerisation of monomers comprising phosphonic acid and/or sulphonic acid groups.

47. A combination of at least one membrane electrode unit of claim 28 and at least one spacer.

48. The combination of claim 47, wherein the spacer forms a frame.

49. The combination of claim 47, wherein the thickness of the spacer decreases over a period of 5 hours by not more than 5% at a temperature of 80° C. and a pressure of 5 N/mm², wherein this decrease in thickness is determined after a first compression step, which takes place over a period of 1 minute at a pressure of 5 N/mm².

50. The combination of claim 47, wherein the thickness of the spacer is 50 to 100%, based on the thickness of all components of the inner area.

51. The combination of claim 47, wherein the spacer comprises polyphenylenes, phenol resins, phenoxy resins, polysulphide ethers, polyphenylenesulphides, polyethersulphones, polyimines, polyetherimines, polyazoles, polybenzimidazoles, polybenzoxazoles, polybenzothiazoles, polybenzoxadiazoles, polybenzotriazoles, polyphosphazenes, polyether ketones, polyketones, polyether ether ketones, polyether ketone ketones, polyphenylene amides, polyphenylene oxides, polyimides, or mixtures thereof.

52. A fuel cell comprising at least one membrane electrode unit of claim 28.

53. The fuel cell of claim 51, wherein the fuel cell comprises at least one spacer.

54. The fuel cell of claim 52, wherein the spacer forms a frame which surrounds the membrane electrode unit.
